(19) United States
(12) Patent Application Publication
(10) Pub. No.: US 2017/0093977 A1
(43) Pub. Date: Mar. 30, 2017

(54) PATTERN TRANMISSION METHOD, CONTROL METHOD, AND SYSTEM

(71) Applicant: FUJITSU LIMITED, Kawasaki-shi (JP)

(72) Inventor: Kouichirou AMEMIYA, Kawasaki (JP)

(73) Assignee: FUJITSU LIMITED, Kawasaki-shi (JP)

(21) Appl. No.: 15/209,169

(22) Filed: Jul. 13, 2016

(30) Foreign Application Priority Data
Sep. 29, 2015 (JP) 2015-191618

(51) Int. Cl. H04L 29/08; H04L 12/26

(52) U.S. Cl. CPC H04L 67/1097; H04L 67/2852; H04L 43/06; H04L 43/04

(57) ABSTRACT

A method is executed by a server that manages a plurality of contents and communicates with a plurality of nodes. The method includes receiving, from a first node among the plurality of nodes, a notification that a first user terminal from among a plurality of user terminals has approached the first node, the plurality of user terminals communicating with one of the plurality of nodes when the plurality of user terminals are within radio communication range of the one of the plurality of nodes, specifying a second user terminal related to the first user terminal, specifying a second node holding a content uploaded by the second user terminal, the second node being from among the plurality of nodes, the content being from among the plurality of contents, and transmitting, to the first node, a message for making the first node download the content from the second node.

### CROSS-REFERENCE TO RELATED APPLICATION

This application is based upon and claims the benefit of priority of the prior Japanese Patent Application No. 2015-191618, filed on Sep. 29, 2015, the entire contents of which are incorporated herein by reference.

### FIELD

The embodiments discussed herein are related to content sharing technology.

### BACKGROUND

In service for sharing a content among a plurality of users, when a content is downloaded from a center server provided on the Internet, the use of a narrow band sometimes lengthens time for transmission. Incidentally, the technology relating to downloading of a content is disclosed in, for example, Japanese Laid-open Patent Publication No. 2004-171052.

### SUMMARY

According to an aspect of the invention, a control method is executed by a server that manages a plurality of contents and communicates with a plurality of nodes. The control method includes receiving, from a first node among the plurality of nodes, a notification that a first user terminal from among a plurality of user terminals has approached the first node, the plurality of user terminals communicating with one of the plurality of nodes when the plurality of user terminals are within radio communication range of the one of the plurality of nodes, specifying a second user terminal related to the first user terminal, specifying a second node holding a content uploaded by the second user terminal, the second node being from among the plurality of nodes, the content being from among the plurality of contents, and transmitting, to the first node, a message for making the first node download the content from the second node.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram depicting a network configuration example of a content sharing system;

FIG. 2 is a diagram depicting a module configuration example of a data center;

FIG. 3 is a diagram depicting an example of data which is stored in a content data storing unit;

FIG. 4 is a diagram depicting an example of a content location table;

FIG. 5 is a diagram depicting an example of an access log table;

FIG. 6 is a diagram depicting an example of an access pattern table;

FIG. 7 is a diagram depicting an example of an approach log table;

FIG. 8 is a diagram depicting an example of a user location table;

FIG. 9 is a diagram depicting an example of relation data;

FIG. 10 is a diagram depicting a module configuration example of an edge node;

FIG. 11 is a diagram depicting an example of an access pattern table;

FIG. 12 is a diagram depicting an example of an access log table;

FIG. 13 is a diagram depicting the general outline of a first phase;

FIG. 14 is a diagram depicting a configuration example of an uploading request;

FIG. 15 is a diagram depicting a configuration example of an uploading notification message;

FIG. 16 is a diagram depicting a first uploading processing flow;

FIG. 17 is a diagram depicting a second uploading processing flow;

FIG. 18 is a diagram depicting the general outline of a second phase;

FIG. 19 is a diagram depicting a configuration example of an access pattern message;

FIG. 20 is a diagram depicting an example of an access pattern;

FIG. 21 is a diagram depicting a first periodic processing flow;

FIG. 22 is a diagram depicting a specifying processing flow;

FIG. 23A is a diagram depicting a distribution processing flow;

FIG. 23B is a diagram depicting the distribution processing flow;

FIG. 24 is a diagram depicting a first registration processing flow;

FIG. 25 is a diagram depicting the general outline of a third phase;

FIG. 26 is a diagram depicting a configuration example of an approach log message;

FIG. 27 is a diagram depicting a configuration example of a placement instruction message;

FIG. 28 is a diagram depicting a configuration example of an advance request message;

FIG. 29 is a diagram depicting a configuration example of an advance response message;

FIG. 30 is a diagram depicting a configuration example of a placement completion message;

FIG. 31 is a diagram depicting a first placement processing (A) flow;

FIG. 32 is a diagram depicting a second placement processing (A) flow;

FIG. 33 is a diagram depicting the second placement processing (A) flow;

FIG. 34 is a diagram depicting a reception processing flow;

FIG. 35 is a diagram depicting a distribution processing (A) flow;

FIG. 36 is a diagram depicting the general outline of a fourth phase;

FIG. 37 is a diagram depicting a configuration example of an access request;

FIG. 38 is a diagram depicting a configuration example of an access log message;

FIG. 39 is a diagram depicting the general outline of the fourth phase;

FIG. 40 is a diagram depicting a configuration example of a content request message;

FIG. 41 is a diagram depicting a first downloading processing flow;

FIG. 42 is a diagram depicting a second downloading processing flow;

FIG. 43 is a diagram depicting a second registration processing flow;

FIG. 44A is a diagram depicting a second periodic processing flow;

FIG. 44B is a diagram depicting the second periodic processing flow;

FIG. 45 is a diagram depicting an example of a compilation table;

FIG. 46 is a diagram depicting a configuration example of a placement instruction message according to a second embodiment;

FIG. 47 is a diagram depicting a configuration example of an advance request message according to the second embodiment;

FIG. 48 is a diagram depicting a configuration example of an advance response message according to the second embodiment;

FIG. 49 is a diagram depicting a first placement processing (B) flow;

FIG. 50 is a diagram depicting a second placement processing (B) flow;

FIG. 51 is a diagram depicting a distribution processing (B) flow; and

FIG. 52 is a diagram of a hardware configuration of a computer.

### DESCRIPTION OF EMBODIMENTS

If a content is cached in advance in an edge server to which a terminal of a user who is about to perform downloading connects, transmission in a wide band will suffice, which shortens the time to acquire the content.

However, for example, if there are many users who are about to download a specific content, a load which is put when the content is distributed to the edge servers tends to increase.

The technology which is disclosed in embodiments increases the efficiency of content distribution among the edge servers.

### First Embodiment

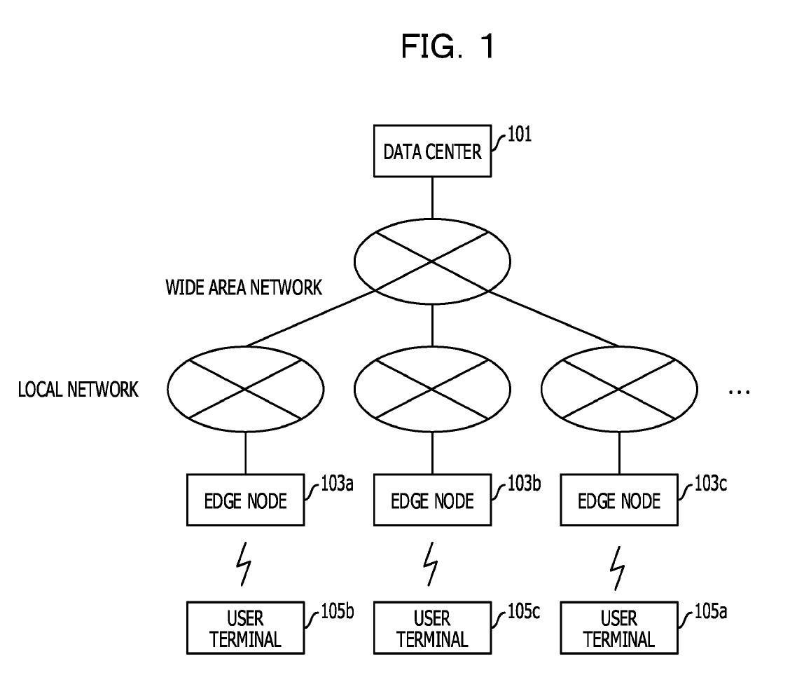

In FIG. 1, a network configuration example of a content sharing system is depicted. The content sharing system includes a data center 101 and a plurality of edge nodes 103. The data center 101 is included in a wide area network.

A user terminal 105 uploads or downloads a content via the edge node 103 provided in a local network.

A content to be shared is held in the data center 101 and is sometimes cached in the edge node 103. The content cached in the edge node 103 is more quickly downloaded to the user terminal 105, because a band in the local network is generally wider than a band in the wide area network.

Moreover, when the user moves, the edge node 103 to which the user terminal 105 connects switches to another edge node 103. The edge node 103 is, for example, a base station in a mobile communication network or an access point in a wireless local-area network (LAN).

In an example which will be described below, when a user terminal 105b connects to an edge node 103a and uploads a content, the content is cached in the edge node 103a.

Furthermore, assume that a user terminal 105a often connects to an edge node 103c in that time period and often downloads the content uploaded by the user terminal 105b immediately. In such a case, if the user terminal 105a approaches the edge node 103c shortly after the caching of the content in the edge node 103a, the edge node 103c requests the content from the edge node 103a in advance.

The edge node 103a acquires an access pattern of the user terminal 105a from the data center 101 and, based on the access pattern, determines that the edge node 103a has to transmit the content to the edge node 103c immediately. Then, even if a conflict between the request from the edge node 103c and a content request from another edge node 103 occurs, the edge node 103a preferentially responds to the request from the edge node 103c.

By doing so, when, for example, there are many users who desire to download immediately the content uploaded via the edge node 103a, it is possible to perform appropriate content distribution in accordance with the behavior pattern of each user.

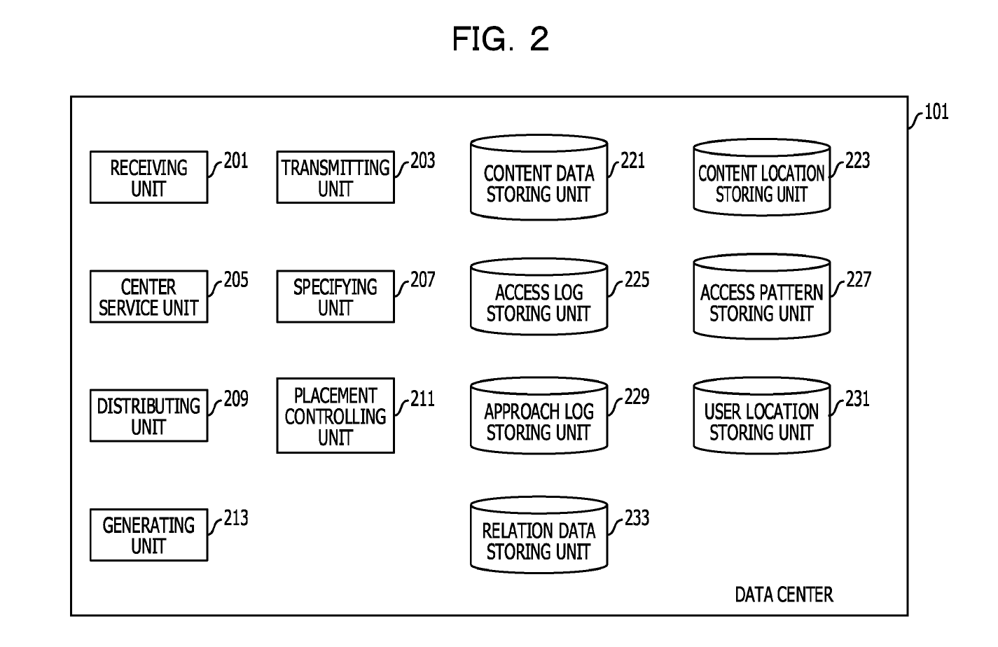

In FIG. 2, a module configuration example of the data center 101 is depicted. The data center 101 includes a receiving unit 201, a transmitting unit 203, a center service unit 205, a specifying unit 207, a distributing unit 209, a placement controlling unit 211, a generating unit 213, a content data storing unit 221, a content location storing unit 223, an access log storing unit 225, an access pattern storing unit 227, an approach log storing unit 229, a user location storing unit 231, and a relation data storing unit 233.

The receiving unit 201 receives various kinds of data. The transmitting unit 203 transmits various kinds of data. The center service unit 205 provides content service in the data center 101. The specifying unit 207 specifies the pattern concerning timing with which access to a content is requested by the user. Furthermore, the specifying unit 207 specifies the location of the user which is predicted in accordance with a time period. The distributing unit 209 distributes an access pattern to the edge nodes 103. The placement controlling unit 211 controls advance placement of a content. The generating unit 213 generates data (referred to as relation data) which relates users to each other.

The content data storing unit 221 stores a content main body and data attached to the content. The content location storing unit 223 stores a content location table that manages a content storage location. The access log storing unit 225 stores an access log table concerning an access request. The access pattern storing unit 227 stores an access pattern table in which timing of the access requests made by the users is compiled. The approach log storing unit 229 stores an approach log table concerning an approach of the user terminal 105 to the edge node 103. The user location storing unit 231 stores a user location table in which the predicted locations of the users are compiled. The relation data storing unit 233 stores relation data.

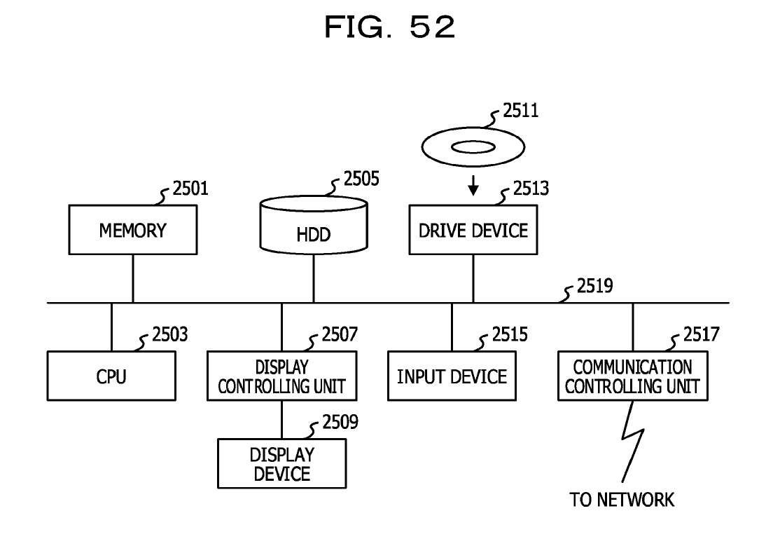

The above-described receiving unit 201, transmitting unit 203, center service unit 205, specifying unit 207, distributing unit 209, placement controlling unit 211, and generating unit 213 are implemented by using hardware resources (for example, FIG. 52) and a program which makes a processor execute processing which will be described below.

The above-described content data storing unit 221, content location storing unit 223, access log storing unit 225, access pattern storing unit 227, approach log storing unit 229, user location storing unit 231, and relation data storing unit 233 are implemented by using hardware resources (for example, FIG. 52).

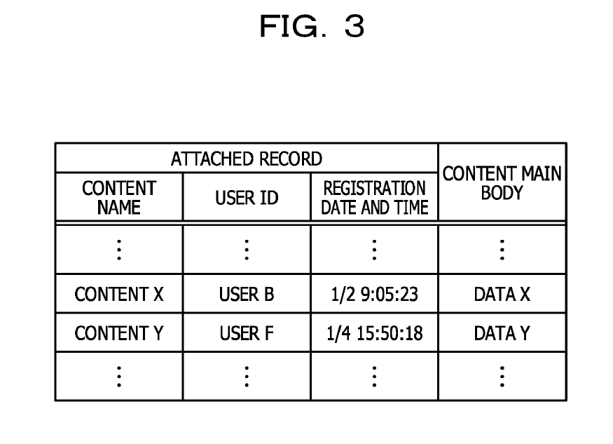

By using FIG. 3, data which is stored in the content data storing unit 221 will be described. The content data storing unit 221 stores a content name, a user ID, and a registration date and time in a state in which the content name, the user ID, and the registration date and time are related to a content main body. In this example, the content name, the user ID, and the registration date and time are set in an attached record.

The content name identifies the content. The user ID is an identifier of the user who registered the content. The registration date and time is a date and time on and at which the content was registered.

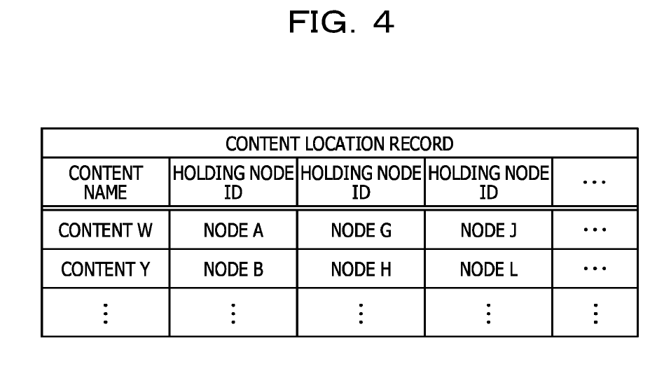

Next, the content location table which is stored in the content location storing unit 223 will be described. In FIG. 4, an example of the content location table is depicted. The content location table in this example has a record (hereinafter referred to as a content location record) corresponding to a content. The content location record has a field for setting a content name and one or more than one field for setting a holding node ID.

The content name identifies the content. The holding node ID is an ID of the edge node 103 holding the content.

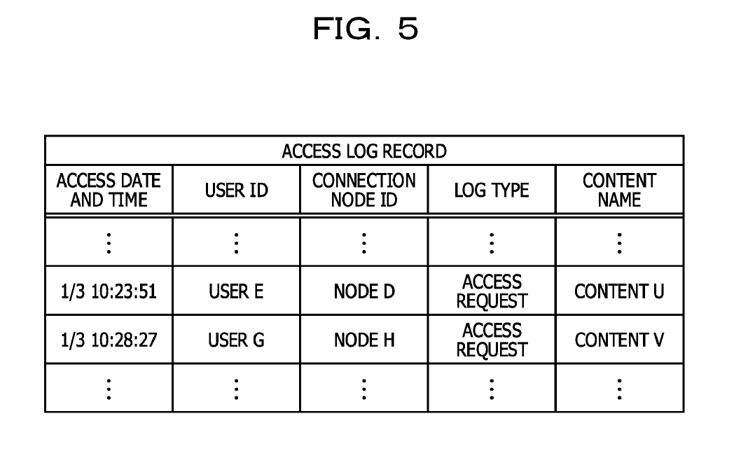

Next, the access log table which is stored in the access log storing unit 225 will be described. In FIG. 5, an example of the access log table is depicted. The access log table in this example has a record (hereinafter referred to as an access log record) corresponding to one content access operation. The access log record has a field for setting an access date and time, a field for setting a user ID, a field for setting a connection node ID, a field for setting a log type, and a field for setting a content name.

The access date and time is a date and time on and at which access to the content was made. The user ID identifies the user who uses the user terminal 105 which transmitted an access request for the content. The user ID may be an identifier of the user terminal 105. The connection node ID is an ID of the edge node 103 connected to the user terminal 105 when the access request was made. In the log type, “access request” is set. “Access request” indicates that this log is an access log. The content name indicates the content to which access was made.

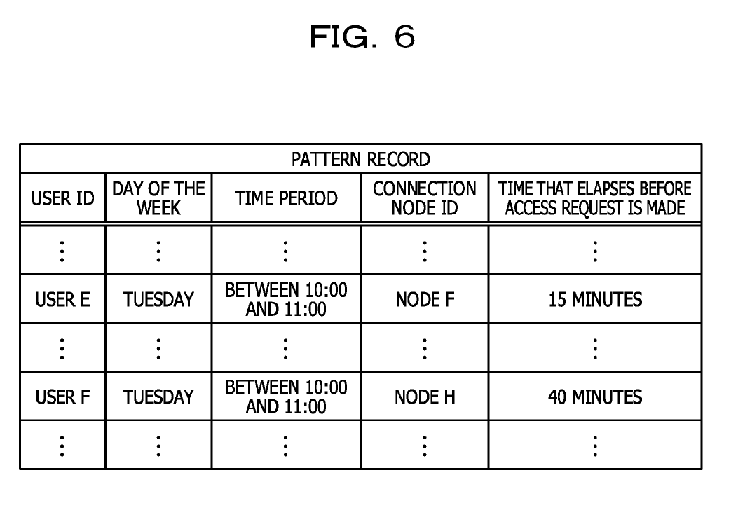

Next, the access pattern table which is stored in the access pattern storing unit 227 will be described. In FIG. 6, an example of the access pattern table is depicted. The access pattern table in this example has a record (hereinafter referred to as a pattern record) corresponding to a combination of a user ID, a day of the week, a time period, and a connection node ID. The pattern record has a field for setting a user ID, a field for setting a day of the week, a field for setting a time period, a field for setting a connection node ID, and a field for setting a time that elapses before an access request is made.

The user ID identifies the user who gives an instruction to make an access request in accordance with this pattern. The day of the week and the time period indicate an expected temporal situation. The connection node ID is an ID of the edge node 103 to which the user terminal 105 is expected to connect in that temporal situation. The connection node ID indicates a locational situation. The time that elapses before an access request is made is a reference time (in this example, an average time based on a track record) from when the user terminal 105 approaches the edge node 103 till when the user terminal 105 transmits an access request in the expected situation.

For example, a first pattern record depicted in FIG. 6 indicates that it is expected that, when the user terminal 105 of a user E approaches a node F between 10:00 and 11:00 on Tuesdays, an access request is transmitted 15 minutes after the approach.

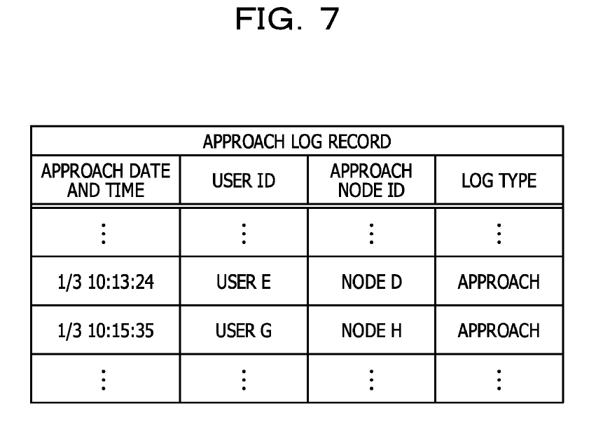

Next, the approach log table which is stored in the approach log storing unit 229 will be described. In FIG. 7, an example of the approach log table is depicted. The approach log table in this example has a record (hereinafter referred to as an approach log record) corresponding to an approach notification received from the user terminal 105 in the edge node 103. The approach log record has a field for setting an approach date and time, a field for setting a user ID, a field for setting an approach node ID, and a field for setting a log type.

The approach date and time is a date and time on and at which the edge node 103 received an approach notification. The user ID identifies the user who uses the user terminal 105 which transmitted the approach notification. The approach node ID is an ID of the edge node 103 which received the approach notification. In the log type, “approach” is set. “Approach” indicates that this log is an approach log.

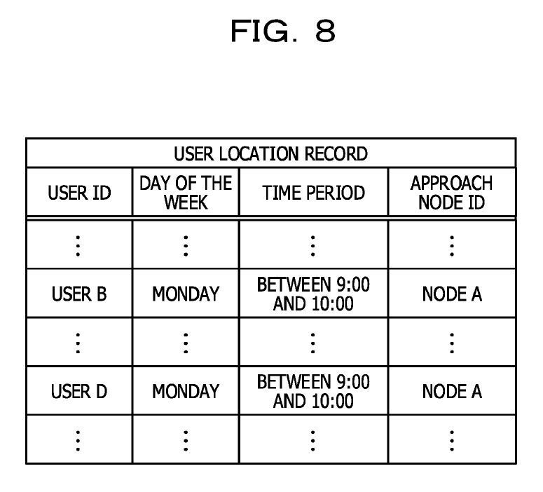

Next, the user location table which is stored in the user location storing unit 231 will be described. In FIG. 8, an example of the user location table is depicted. The user location table in this example has a record (hereinafter referred to as a user location record) corresponding to a user ID, a day of the week, and a time period. The user location record has a field for setting a user ID, a field for setting a day of the week, a field for setting a time period, and a field for setting an approach node ID.

The user ID identifies the user whose location is to be specified. The day of the week and the time period indicate an expected temporal situation. The approach node ID is an ID of the edge node 103 which the user terminal 105 of the user is highly likely to approach in that temporal situation. That is, the approach node ID indicates the expected location of the user.

For example, a first user location record depicted in FIG. 8 indicates that a user B is highly likely to be located near the edge node 103 which is a node A between 9:00 and 10:00 on Mondays.

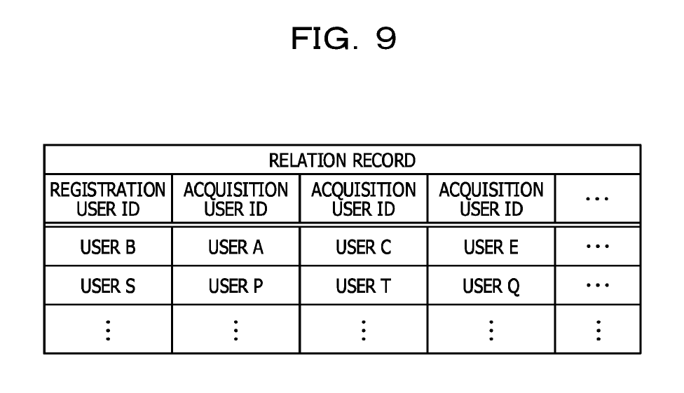

Next, the relation data which is stored in the relation data storing unit 233 will be described. In FIG. 9, an example of the relation data is depicted. The relation data in this example is presented in tabular form. However, the relation data may be presented in any forms other than tabular form. The relation data in this example has a record (hereinafter referred to as a relation record) corresponding to a user (referred to as a registration user) who registered a content.

The relation record has a field for setting a registration user ID and one or more than one field for setting an acquisition user ID. The registration user ID identifies the registration user of the content, that is, the user who provides the content. The acquisition user ID identifies the user (referred to as the acquisition user) who acquired the content provided by the registration user.

For example, a first relation record depicted in FIG. 9 indicates that, when a user B uploads a content, a user A, a user C, and a user E tend to download the content frequently.

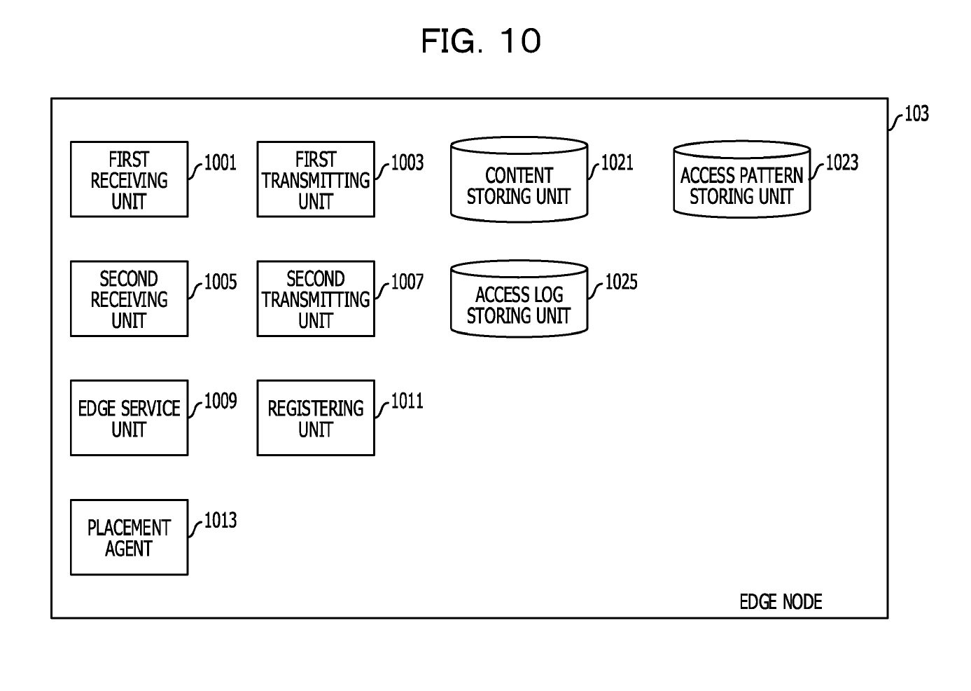

Then, each edge node 103 will be described. In FIG. 10, a module configuration example of the edge node 103 is depicted. The edge node 103 includes a first receiving unit 1001, a first transmitting unit 1003, a second receiving unit 1005, a second transmitting unit 1007, an edge service unit 1009, a registering unit 1011, a placement agent 1013, a content storing unit 1021, an access pattern storing unit 1023, and an access log storing unit 1025.

The first receiving unit 1001 receives various kinds of data via the local network. The first transmitting unit 1003 transmits various kinds of data via the local network. The second receiving unit 1005 receives various kinds of data from the user terminal 105 by a radio medium. The second transmitting unit 1007 transmits various kinds of data to the user terminal 105 by the radio medium. The edge service unit 1009 provides content service in the edge node 103. The registering unit 1011 registers an access pattern. The placement agent 1013 performs advance placement of a content.

The content storing unit 1021 stores a content main body in a state in which the content main body is related to a content name. The access pattern storing unit 1023 stores an access pattern table. The access log storing unit 1025 stores an access log table.

The above-described first receiving unit 1001, first transmitting unit 1003, second receiving unit 1005, second transmitting unit 1007, edge service unit 1009, registering unit 1011, and placement agent 1013 are implemented by using hardware resources (for example, FIG. 52) and a program which makes a processor execute processing which will be described below.

The above-described content storing unit 1021, access pattern storing unit 1023, and access log storing unit 1025 are implemented by using hardware resources (for example, FIG. 52).

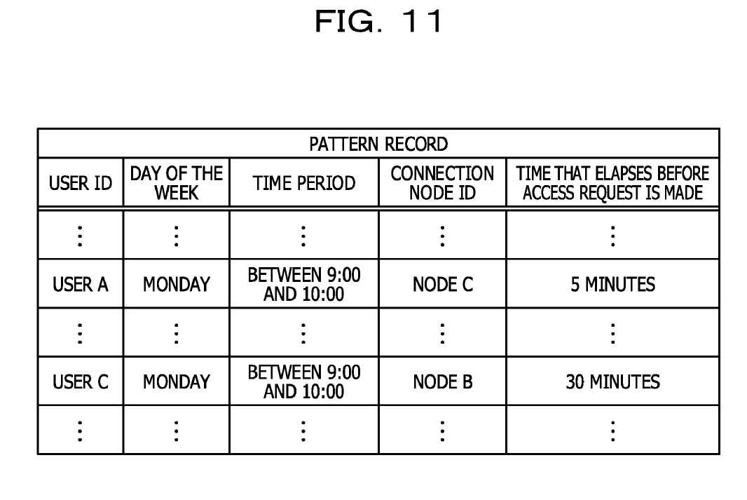

Next, the access pattern table which is stored in the access pattern storing unit 1023 will be described. In FIG. 11, an example of the access pattern table is depicted. The configuration of the access pattern table which is stored in the access pattern storing unit 1023 is the same as the configuration of the access pattern table which is stored in the access pattern storing unit 227 in the data center 101. In the access pattern table which is stored in the access pattern storing unit 1023, some of the pattern records in the access pattern table which is stored in the access pattern storing unit 227 are stored.

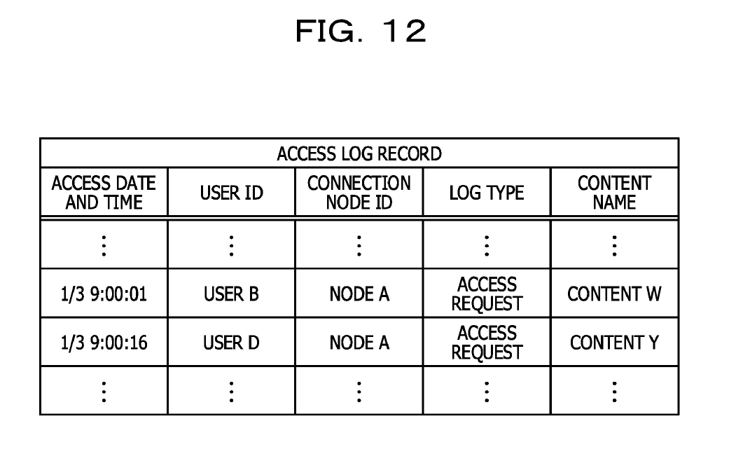

Next, the access log table which is stored in the access log storing unit 1025 will be described. In FIG. 12, an example of the access log table is depicted. The configuration of the access log table which is stored in the access log storing unit 1025 is the same as the access log table which is stored in the access log storing unit 225 in the data center 101. The access log table which is stored in the access log storing unit 1025 includes an access log record related to an access request received in the edge node 103.

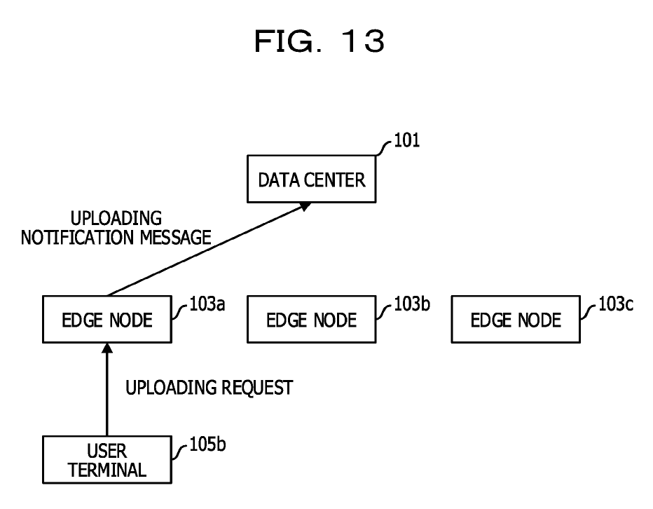

Hereinafter, an operation of the content sharing system will be described in first to fifth phases. In FIG. 13, the general outline of the first phase is depicted. In the first phase, a content is uploaded. In this example, an uploading request is transmitted to the edge node 103a from the user terminal 105b.

The content main body is included in the uploading request. The content main body is cached in the edge node 103 and transferred to the data center 101 in the form of an uploading notification message.

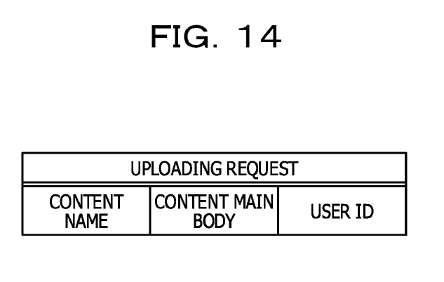

In FIG. 14, a configuration example of the uploading request is depicted. The uploading request includes a content name, a content main body, and a user ID. The content name identifies a content to be uploaded. The content main body is data to be uploaded. The content main body is data in image or audio format, for example. The user ID is an ID of a user who requests uploading.

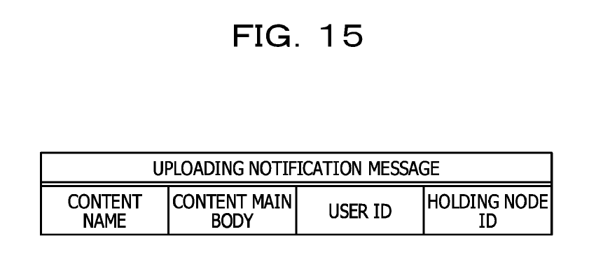

In FIG. 15, a configuration example of the uploading notification message is depicted. The uploading notification message includes a content name, a content main body, a user ID, and a holding node ID. The content name identifies the uploaded content. The content main body is uploaded data. The user ID is an ID of the user who requested uploading. The holding node ID is an ID of the edge node 103 holding the uploaded content.

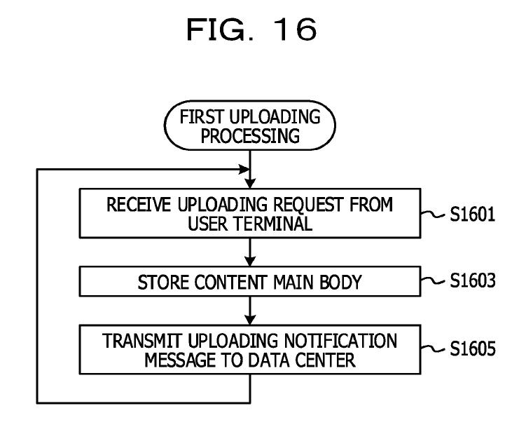

First uploading processing in the edge node 103 will be described. In FIG. 16, a first uploading processing flow is depicted. When the second receiving unit 1005 receives an uploading request from the user terminal 105 (S1601), the edge service unit 1009 stores a content main body included in the uploading request in the content storing unit 1021 in a state in which the content main body is related to a content name (S1603). Then, the first transmitting unit 1003 transmits an uploading notification message to the data center 101 (S1605).

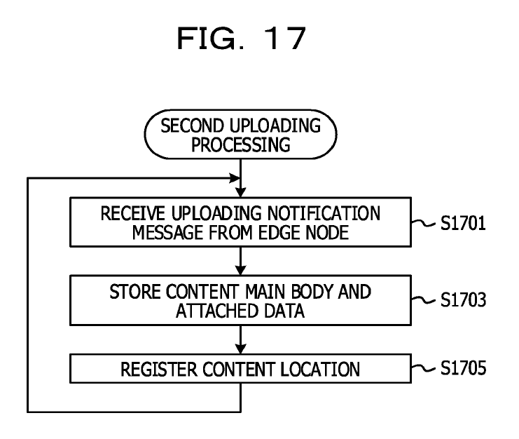

Next, second uploading processing in the data center 101 will be described. In FIG. 17, a second uploading processing flow is depicted. When the receiving unit 201 receives an uploading notification message from the edge node 103 (S1701), the center service unit 205 stores a content main body and attached data (a content name, a user ID, and a registration date and time) in the content data storing unit 221 (S1703). Moreover, the center service unit 205 registers a content location in the content location table (S1705). Specifically, if there is a content location record in which the content name is set, the center service unit 205 sets, in that record, an ID of the edge node 103 which is the transmission source of the uploading notification message in a new field of the holding node ID; if there is not a content location record in which the content name is set, the center service unit 205 adds a new content location record and sets the content name and the holding node ID.

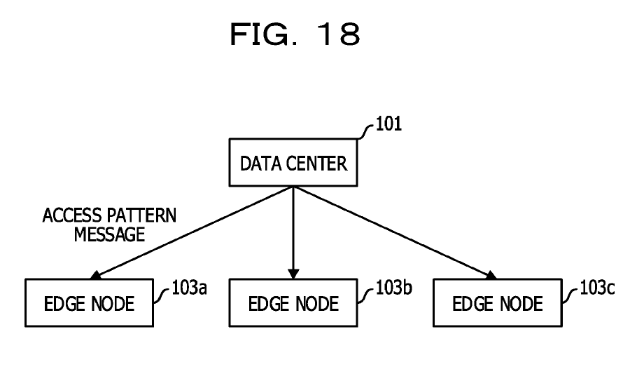

Next, the second phase will be described. In FIG. 18, the general outline of the second phase is depicted. In the second phase, an access pattern of the user is selectively distributed among the edge nodes 103. The access pattern which is transmitted in this example takes the form of a message.

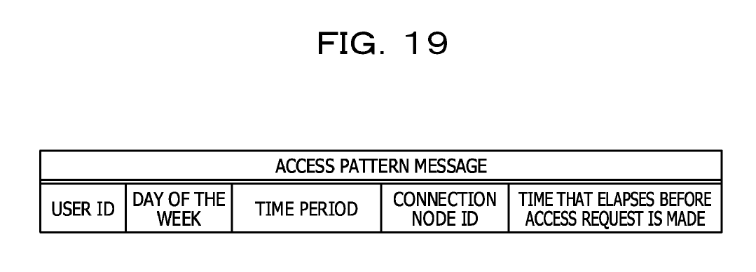

In FIG. 19, a configuration example of the access pattern message is depicted. The access pattern message includes a user ID, a day of the week, a time period, a connection node ID, and a time that elapses before an access request is made. The user ID identifies the user who gives an instruction to make an access request in accordance with this pattern. The day of the week and the time period indicate an expected temporal situation. The connection node ID is an ID of the edge node 103 to which the user terminal 105 is expected to connect in that temporal situation. The connection node ID indicates a locational situation. The time that elapses before an access request is made is a reference time (in this example, an average time based on a track record) from when the user terminal 105 approaches the edge node 103 till when the user terminal 105 transmits an access request in the expected situation.

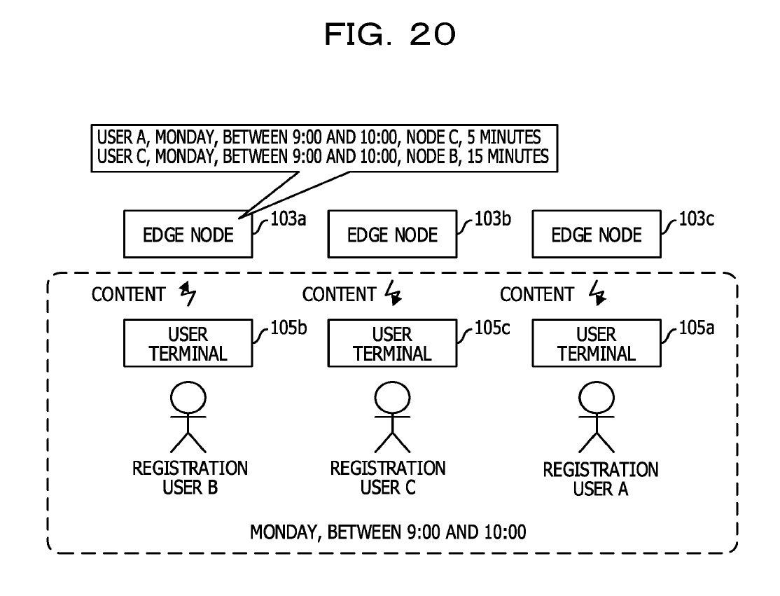

The access pattern will be further described. In FIG. 20, an example of the access pattern is depicted. For example, it is assumed that the edge node 103a holds an access pattern indicating that a user A (a user of the user terminal 105a) often makes an attempt to download a content 5 minutes after the user A approaches the edge node 103c between 9:00 and 10:00 on Mondays. Furthermore, it is assumed that the edge node 103a holds an access pattern indicating that a user C (a user of the user terminal 105c) often makes an attempt to download a content 15 minutes after the user C approaches the edge node 103b also between 9:00 and 10:00 on Mondays.

Moreover, it is assumed that the user A and the user C frequently download the content uploaded by a user B (a user of the user terminal 105b). That is, the user B is a user who registers the content and the user A and the user C are users who acquire the content registered by the user B. In such a case, the user A and the user C are closely related to the user B. It is assumed that the relationship between the users A and C and the user B is managed by relation data in the data center 101.

Assume that the user B has approached the edge node 103a and uploaded a new content between 9:00 and 10:00 on a Monday. It is assumed that, around that time, the user A is approaching the edge node 103c and, likewise, the user C is approaching the edge node 103b.

In such a case, in both the edge node 103b and the edge node 103c, an operation of caching the new content in advance is performed. That is, both the edge node 103b and the edge node 103c request a content from the edge node 103a in advance.

If the edge node 103b and the edge node 103c request the new content from the edge node 103a at the same time, the user A habitually tends to make an attempt to download the content earlier than the user C. The edge node 103a transmits the new content to the edge node 103c earlier than the edge node 103b in response to that tendency based on the access pattern of the user A.

On the other hand, the user C tends to download a content without haste. The edge node 103a transmits the new content to the edge node 103b after transmitting the new content to the edge node 103c in response to that tendency based on the access pattern of the user C.

By performing distribution of a content in such a way as to be temporally shifted in the above-described manner, even when the transmission load in the edge node 103a increases, it is possible to complete advance caching without a hitch.

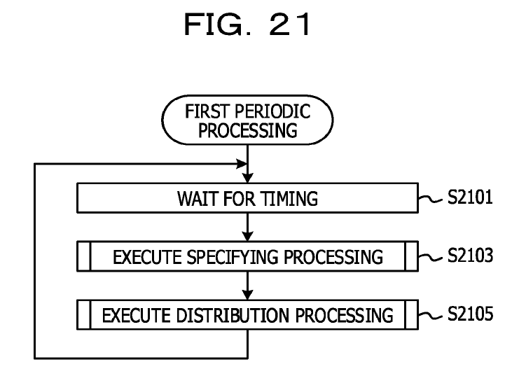

Processing in the second phase will be described. First, first periodic processing in the data center 101 will be described. In FIG. 21, a first periodic processing flow is depicted. In the first periodic processing, a daily data update is performed. The specifying unit 207 waits for timing in accordance with a predetermined cycle (S2101).

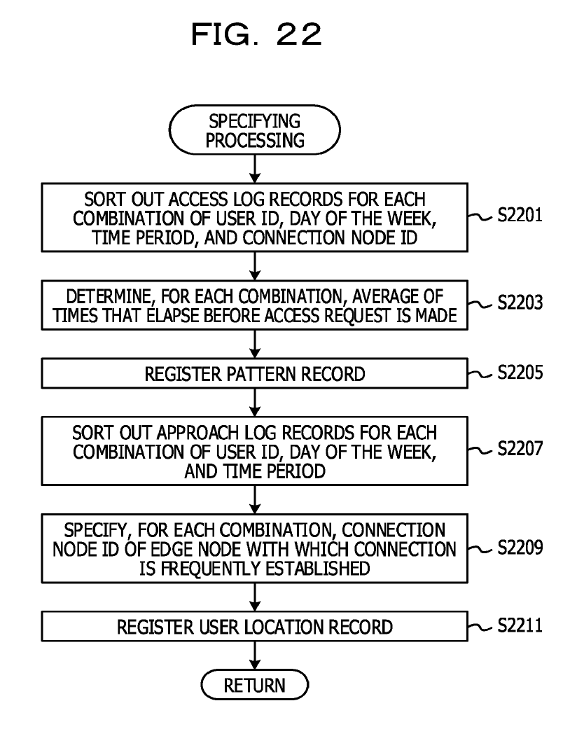

With appropriate timing, the specifying unit 207 executes specifying processing (S2103). In the specifying processing, the specifying unit 207 specifies the pattern of access to a content and the expected location of the user. In FIG. 22, a specifying processing flow is depicted. The specifying unit 207 sorts out the access log records included in the access log table for each combination of the user ID, the day of the week, the time period, and the connection node ID (S2201). The day of the week and the time period are specified based on the access date and time. The specifying unit 207 determines, for each combination, an average of the times that elapse before an access request is made (S2203). Then, the specifying unit 207 registers a pattern record corresponding to each combination in the access pattern table (S2205).

The specifying unit 207 sorts out the approach log records included in the approach log table for each combination of the user ID, the day of the week, and the time period (S2207). The day of the week and the time period are specified based on the approach date and time. The specifying unit 207 specifies, for each combination, the connection node ID of the edge node 103 with which connection is frequently established (S2209). Then, the specifying unit 207 registers a user location record corresponding to each combination in the user location table (S2211). When the specifying processing is ended, the procedure returns to the first periodic processing which is the call source.

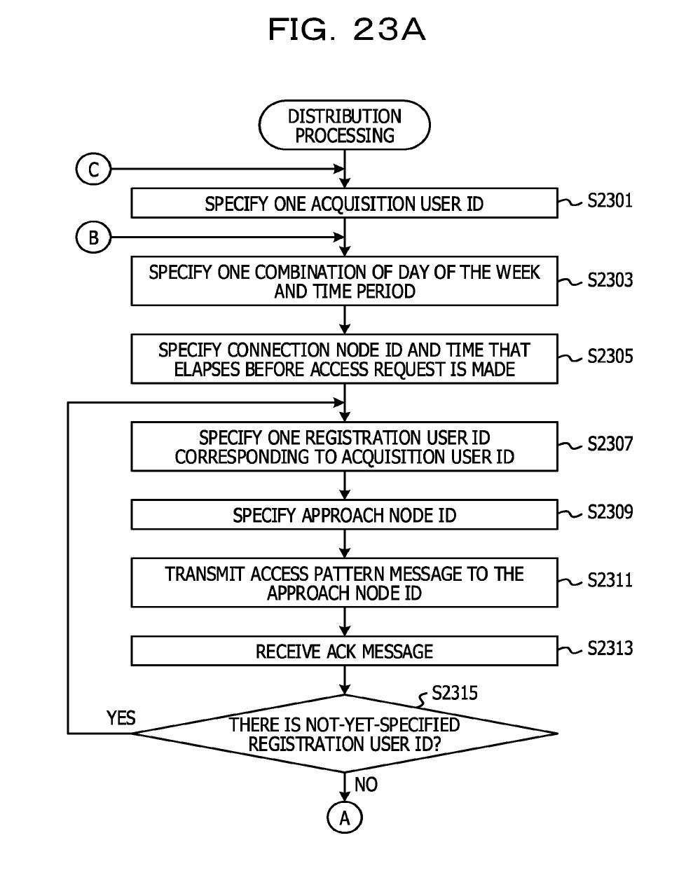

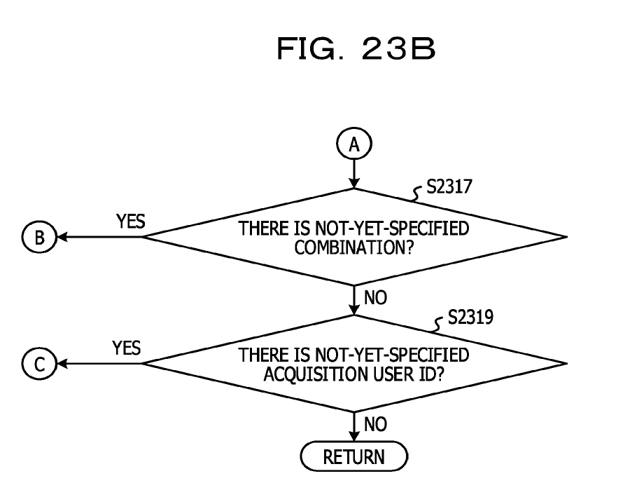

Back in FIG. 21, the distributing unit 209 executes distribution processing (S2105). In the distribution processing, the distributing unit 209 distributes an access pattern message to the edge node 103. In FIGS. 23A and 23B, a distribution processing flow is depicted. The distributing unit 209 specifies one acquisition user ID which is managed by the relation data (S2301). Furthermore, the distributing unit 209 specifies one combination of the day of the week and the time period (S2303). It is assumed that the combination of the day of the week and the time period, the combination which is specified at this time, is determined in advance.

The distributing unit 209 specifies, of the pattern records of the access pattern table, the pattern record corresponding to the acquisition user ID and the combination of the day of the week and the time period. Then, the distributing unit 209 specifies the connection node ID and the time that elapses before an access request is made, the connection node ID and the time which are set in the pattern record (S2305).

The distributing unit 209 specifies one registration user ID corresponding to the acquisition user ID from the relation records included in the relation data (S2307).

The distributing unit 209 specifies, of the user location records of the user location table, the user location record corresponding to the registration user ID and the combination of the day of the week and the time period. Then, the distributing unit 209 specifies the approach node ID set in the user location record (S2309). The approach node ID corresponds to the location of the registration user in the expected situation.

The distributing unit 209 transmits, to the approach node ID specified in S2309, an access pattern message including the acquisition user ID specified in S2301, the day of the week, the time period, and the connection node ID and the time that elapses before an access request is made, the connection node ID and the time specified in S2305, via the transmitting unit 203 (S2311).

When the receiving unit 201 receives an acknowledgement (ACK) message (S2313), the distributing unit 209 judges whether or not there is a registration user ID which is not yet specified in S2307 (S2315). If the distributing unit 209 judges that there is a not-yet-specified registration user ID, the procedure goes back to the processing described in S2307 and the above-described processing is repeated.

On the other hand, if the distributing unit 209 judges that there is not a not-yet-specified registration user ID, the procedure proceeds to processing in S2317 depicted in FIG. 23B via a terminal A. The distributing unit 209 judges whether or not there is a combination which is not yet specified in S2303 (S2317). If the distributing unit 209 judges that there is a not-yet-specified combination, the procedure goes back to the processing described in S2303 of FIG. 23A via a terminal B and the above-described processing is repeated.

On the other hand, if the distributing unit 209 judges that there is not a not-yet-specified combination, the distributing unit 209 judges whether or not there is an acquisition user ID which is not yet specified in S2301 (S2319). If the distributing unit 209 judges that there is a not-yet-specified acquisition user ID, the procedure goes back to the processing described in S2301 of FIG. 23A via a terminal C and the above-described processing is repeated.

On the other hand, if the distributing unit 209 judges that there is not a not-yet-specified acquisition user ID, the procedure returns to the first periodic processing which is the call source.

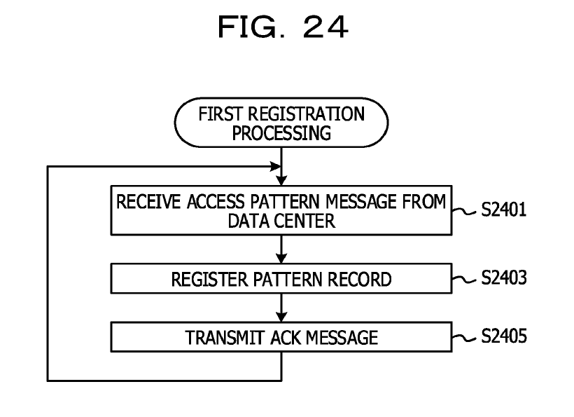

Next, first registration processing in the edge node 103 will be described. In the first registration processing, an access pattern is registered in the access pattern table. In FIG. 24, a first registration processing flow is depicted. When the first receiving unit 1001 receives an access pattern message from the data center 101 (S2401), the registering unit 1011 registers a pattern record in the access pattern table based on the access pattern message (S2403). The first transmitting unit 1003 transmits an ACK message to the data center 101 (S2405), and the procedure goes back to the processing described in S2401 and the above-described processing is repeated.

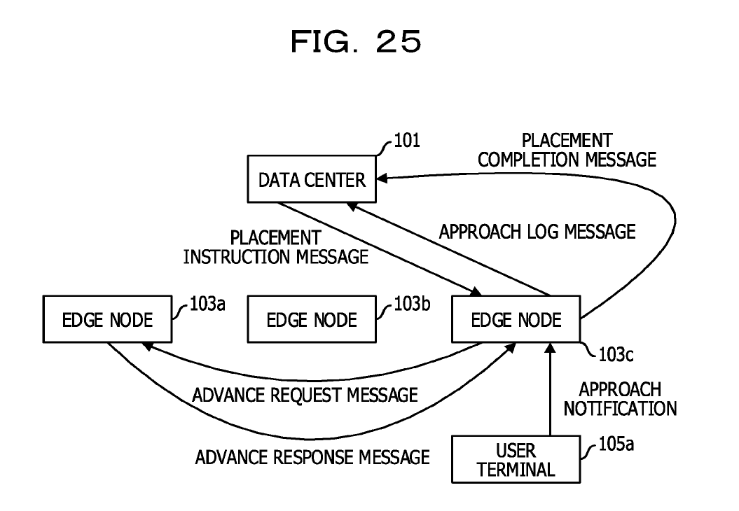

Next, the third phase will be described. In FIG. 25, the general outline of the third phase will be described. In the third phase, a content is downloaded. In this example, when the user terminal 105a approaches the edge node 103c, the edge node 103c receives an approach notification from the user terminal 105a. The approach notification includes a user ID.

The edge node 103c transmits an approach log message to the data center 101. The data center 101 records the location of the user terminal 105a. Moreover, the data center 101 selects in advance a content which is placed in the edge node 103c in preparation for an access request by the user terminal 105a.

A placement instruction message which is transmitted to the edge node 103c from the data center 101 includes the name of a content which the edge node 103c caches in advance and an ID of another edge node 103 which has already cached the content. In this example, it is assumed that a desired content is cached in the edge node 103a.

The edge node 103c transmits an advance request message to the edge node 103a. Then, the edge node 103a distributes the content in response to the advance request message. The content is transmitted in the form of an advance response message.

When the edge node 103c caches the content, the edge node 103c provides a notification to that effect to the data center 101 by a placement completion message.

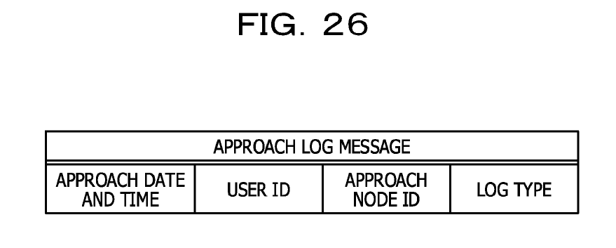

Hereinafter, the messages which are used in the third phase will be described. In FIG. 26, a configuration example of the approach log message is depicted. The approach log message includes an approach date and time, a user ID, an approach node ID, and a log type. The approach date and time is a date and time on and at which the edge node 103 received an approach notification. The user ID identifies the user who uses the user terminal 105 which transmitted the approach notification. The approach node ID is an ID of the edge node 103 which received the approach notification. In the log type, “approach” is set. “Approach” indicates that this log is an approach log.

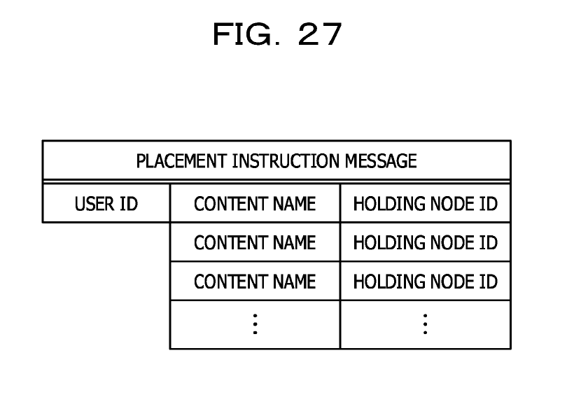

In FIG. 27, a configuration example of the placement instruction message is depicted. The placement instruction message includes a user ID, a content name, and a holding node ID. A set of the content name and the holding node ID corresponds to an entry. Moreover, there is one or more than one entry. The user ID identifies the user who uses the user terminal 105 which approached the edge node 103. An approach of the user to the edge node 103 triggers placement of a content. The content name identifies a content to be placed. The holding node ID is an ID of the edge node 103 holding the content to be placed. This edge node 103 provides the content to be placed.

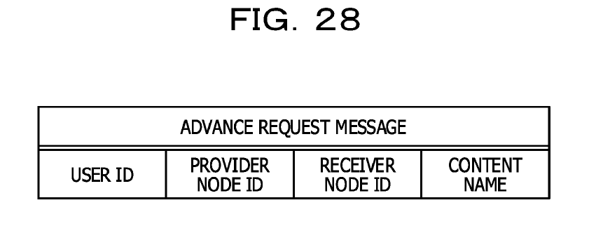

In FIG. 28, a configuration example of the advance request message is depicted. The advance request message includes a user ID, a provider node ID, a receiver node ID, and a content name. The user ID included in the advance request message coincides with the user ID included in the placement instruction message. This user may access a content which is requested in advance. The provider node ID is an ID of the edge node 103 that provides the content which is requested in advance. The receiver node ID is an ID of the edge node 103 that receives the content which is requested. The content name identifies the content which is requested.

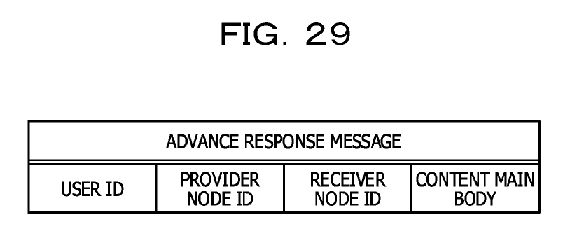

In FIG. 29, a configuration example of the advance response message is depicted. The advance response message includes a user ID, a provider node ID, a receiver node ID, and a content main body. The user ID included in the advance response message coincides with the user ID included in the advance request message. The provider node ID included in the advance response message coincides with the provider node ID included in the advance request message. The receiver node ID included in the advance response message coincides with the receiver node ID included in the advance request message. The content main body is specified by the content name included in the advance request message.

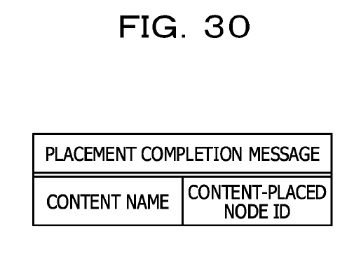

In FIG. 30, a configuration example of the placement completion message is depicted. The placement completion message includes a content name and a content-placed node ID. The content name identifies the content which was placed. The content-placed node ID is an ID of the edge node 103 in which the content was placed. The content-placed node ID coincides with the receiver node IDs included in the advance request message and the advance response message.

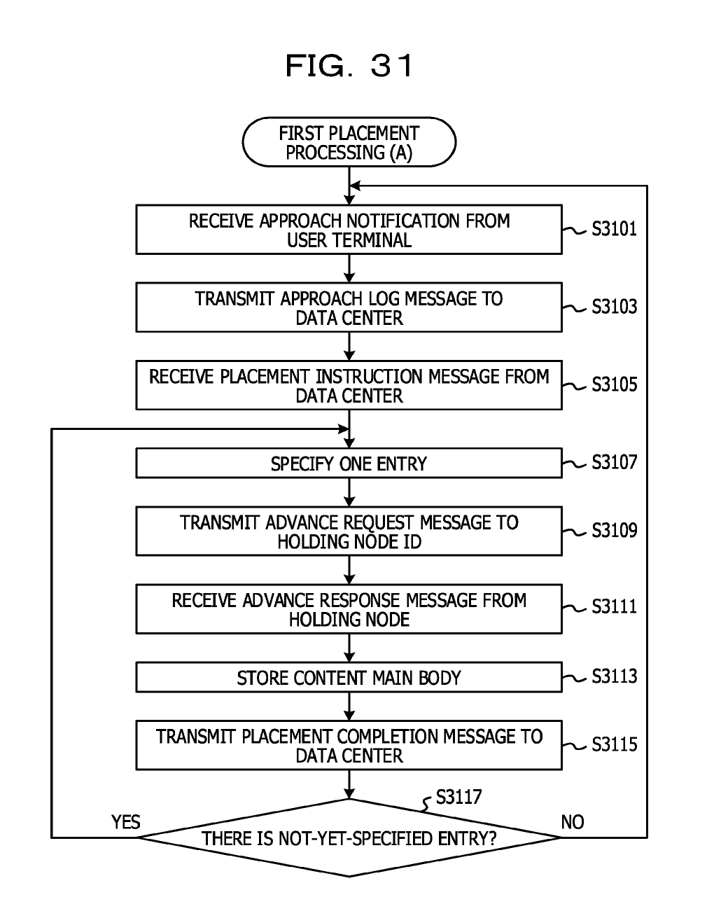

Then, processing in the third phase will be described. First, first placement processing (A) in the edge node 103 will be described. In the first placement processing (A), the edge node 103 secures a content in advance. In FIG. 31, a first placement processing (A) flow is depicted. When the second receiving unit 1005 receives an approach notification from the user terminal 105 (S3101), the placement agent 1013 transmits an approach log message to the data center 101 via the first transmitting unit 1003 (S3103). In this example, the date of the day on which the approach notification was received and the current time are set in the approach date and time of the approach log message. The user ID included in the approach notification is set in the approach log message. The ID of this edge node 103 is set as the approach node ID of the approach log message.

Then, when the first receiving unit 1001 receives a placement instruction message from the data center 101 (S3105), the placement agent 1013 specifies one entry, that is, one set of the content name and the holding node ID included in the placement instruction message (S3107).

The placement agent 1013 transmits an advance request message to the holding node ID via the first transmitting unit 1003 (S3109). In this example, the user ID included in the approach notification is set in the advance request message. The holding node ID is set as the provider node ID of the advance request message. The ID of this edge node 103 is set as the receiver node ID of the advance request message. The content name of the entry specified in S3107 is set in the advance request message.

Then, when the first receiving unit 1001 receives an advance response message from the holding node (S3111), the placement agent 1013 stores the content main body in the content storing unit 1021 in a state in which the content name is attached thereto (S3113).

The placement agent 1013 transmits a placement completion message to the data center 101 via the first transmitting unit 1003 (S3115). At this time, the content name included in the advance request message is set in the placement completion message. The ID of this edge node 103 is set as the content-placed node ID of the placement completion message.

The placement agent 1013 judges whether or not there is an entry which is not yet specified in S3107 (S3117). If the placement agent 1013 judges that there is a not-yet-specified entry, the procedure goes back to the processing described in S3107 and the above-described processing is repeated.

On the other hand, if the placement agent 1013 judges that there is not a not-yet-specified entry, the procedure goes back to the processing described in S3101 and the above-described processing is repeated.

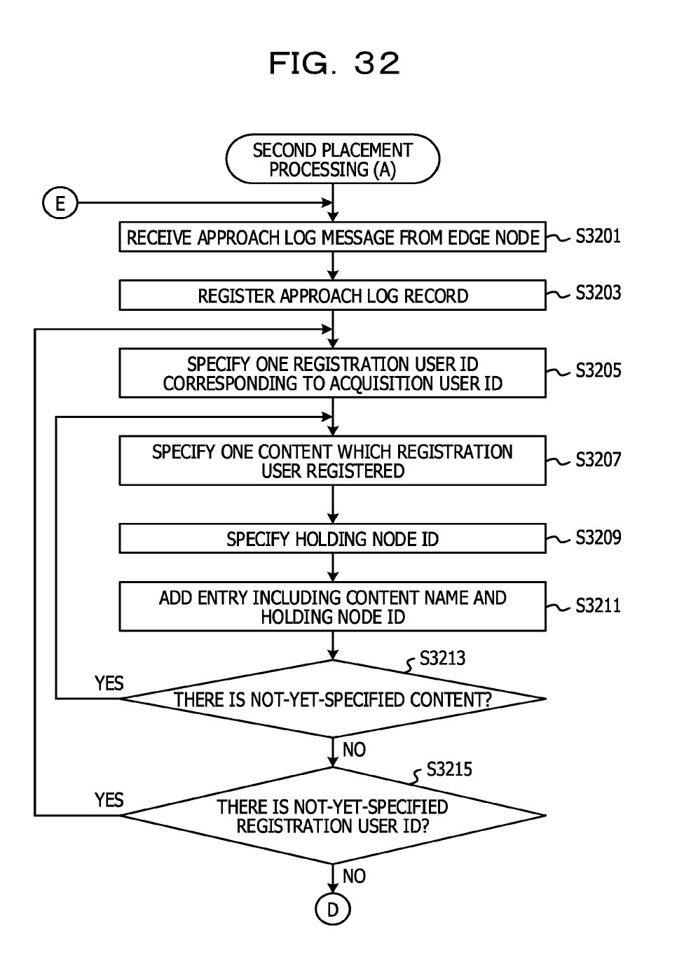

Next, second placement processing (A) in the data center 101 will be described. In the second placement processing (A), an instruction to place a content is given to the edge node 103 which is the transmission source of an approach log message. In FIG. 32, a second placement processing (A) flow is depicted. When the transmitting unit 203 receives an approach log message from the edge node 103 (S3201), the placement controlling unit 211 registers an approach log record in the approach log table based on the approach log message (S3203).

The placement controlling unit 211 specifies one registration user ID corresponding to the acquisition user ID from the relation records included in the relation data (S3205).

The placement controlling unit 211 specifies one content which the registration user registered (S3207). Specifically, the placement controlling unit 211 specifies, of the attached records stored in the content data storing unit 221, the content name set in the attached record including the registration user ID.

The placement controlling unit 211 specifies one holding node ID of one or more than one holding node ID corresponding to the content name in the content location table (S3209). For example, the placement controlling unit 211 selects the ID of the edge node 103 close to the edge node 103 which is the transmission source of the approach log message. The placement controlling unit 211 adds, to the placement instruction message, an entry including the content name and the specified holding node ID (S3211).

The placement controlling unit 211 judges whether or not there is a content which is not yet specified in S3207 (S3213). If the placement controlling unit 211 judges that there is a not-yet-specified content, the procedure goes back to the processing described in S3207 and the above-described processing is repeated.

On the other hand, if the placement controlling unit 211 judges that there is not a not-yet-specified content, the placement controlling unit 211 judges whether or not there is a registration user ID which is not yet specified in S3205 (S3215). If the placement controlling unit 211 judges that there is a not-yet-specified registration user ID, the procedure goes back to the processing described in S3205 and the above-described processing is repeated.

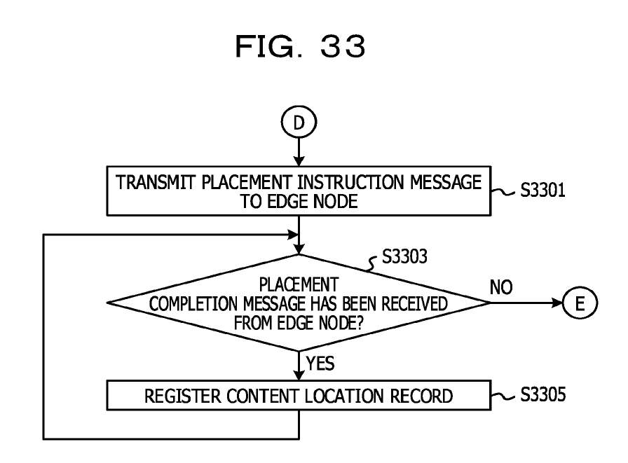

On the other hand, if the placement controlling unit 211 judges that there is not a not-yet-specified registration user ID, the procedure proceeds to processing in S3301 depicted in FIG. 33 via a terminal D.

The description of FIG. 33 will be given below. The placement controlling unit 211 transmits a placement instruction message to the edge node 103 via the transmitting unit 203 (S3301). In this example, the user ID included in the approach log message is set in the placement instruction message.

The receiving unit 201 judges whether or not a placement completion message has been received from the edge node 103 which is the destination of the placement instruction message in a predetermined time (S3303).

If the receiving unit 201 judges that a placement completion message has been received in the predetermined time, the placement controlling unit 211 registers a content location record in the content location table based on the placement completion message (S3305). Specifically, if there is a content location record in which the content name included in the placement completion message is set, the placement controlling unit 211 sets, in that record, the content-placed node ID included in the placement completion message in a new field of the holding node ID; if there is not a content location record in which the content name included in the placement completion message is set, the placement controlling unit 211 adds a new content location record and sets the content name and the content-placed node ID which are included in the placement completion message. Then, the procedure goes back to the processing described in S3303 and the above-described processing is repeated.

On the other hand, if the receiving unit 201 judges that a placement completion message has not been received in the predetermined time, the procedure goes back to the processing in S3201 depicted in FIG. 32 via a terminal E.

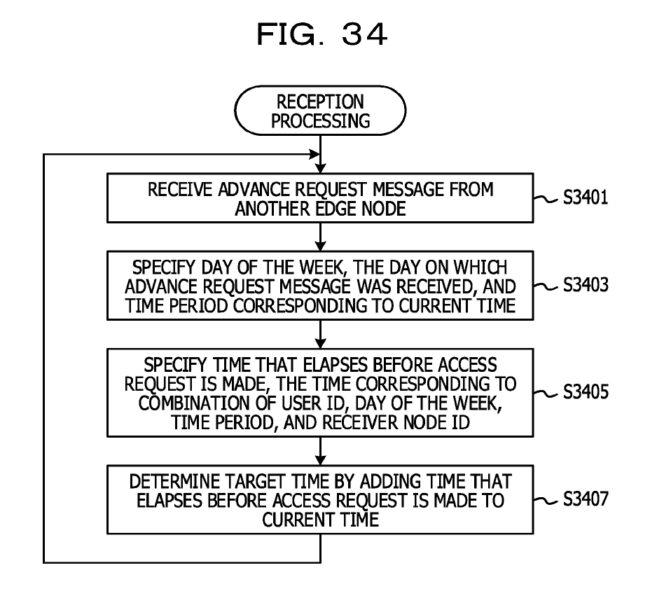

Next, processing in the edge node 103 which provides a content will be described. In FIG. 34, a reception processing flow is depicted. In the reception processing, an advance request message is received and a target time at which an advance response message to the advance request message is transmitted is set.

When the first receiving unit 1001 receives an advance request message from another edge node 103 (S3401), the placement agent 1013 specifies a day of the week, the day on which the advance request message was received, and a time period corresponding to the current time (S3403).

The placement agent 1013 specifies, of the pattern records included in the access pattern table, the pattern record corresponding to the combination of the user ID set in the advance request message, the specified day of the week, the day on which the advance request message was received, the current time period, and the receiver node ID set in the advance request message. Incidentally, the receiver node ID set in the advance request message corresponds to the connection node ID in the pattern record. Then, the placement agent 1013 specifies the time that elapses before an access request is made, the time set in the specified pattern record (S3405).

The placement agent 1013 determines a target time by adding the specified time that elapses before an access request is made to the current time (S3407). Then, the procedure goes back to the processing described in S3401 and the above-described processing is repeated.

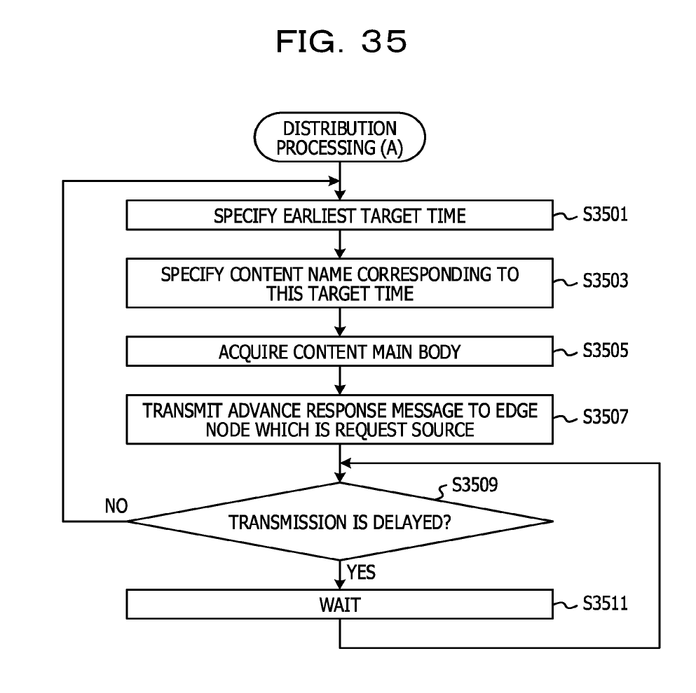

Next, distribution processing (A) in the edge node 103 will be described. In the distribution processing (A), an advance response message is transmitted in accordance with the target time. That is, distribution of a content is performed. In FIG. 35, a distribution processing (A) flow is depicted. The placement agent 1013 specifies the earliest target time of the target times for an unprocessed advance request message (S3501). The placement agent 1013 specifies the content name included in the advance request message corresponding to this target time (S3503). If there is not an unprocessed advance request message, the placement agent 1013 waits in S3501.

The placement agent 1013 acquires the content main body specified by the specified content name from the content storing unit 1021 (S3505). The placement agent 1013 transmits an advance response message to the edge node 103 which is the request source via the first transmitting unit 1003 (S3507). In this example, the placement agent 1013 includes the user ID, the provider node ID, and the receiver node ID which are included in the advance request message in the advance response message. Moreover, the placement agent 1013 includes the content main body acquired in S3505 in the advance response message.

The placement agent 1013 judges whether or not transmission in this edge node 103 is delayed (S3509). If the placement agent 1013 judges that transmission is not delayed, the procedure goes back to the processing described in S3501 and the above-described processing is repeated.

On the other hand, if the placement agent 1013 judges that transmission is delayed, the placement agent 1013 waits for a predetermined time (S3511) and makes a judgment in S3509 again.

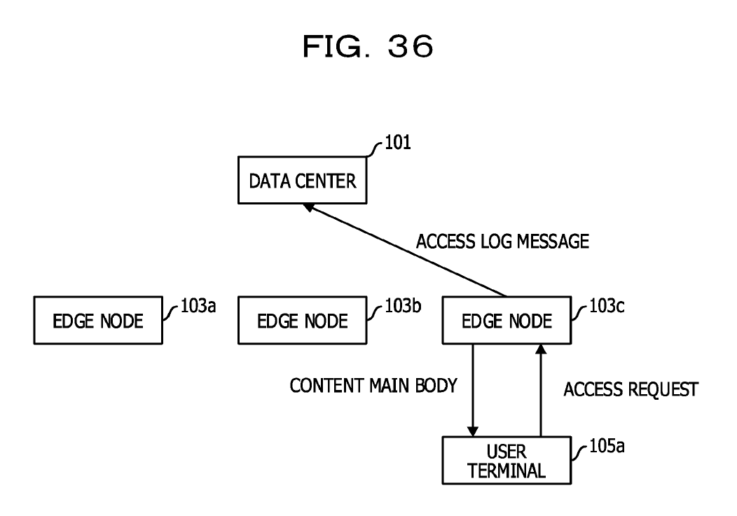

Next, the fourth phase will be described. In FIG. 36, the general outline of the fourth phase is depicted. In the fourth phase, a content main body is downloaded. In this example, the user terminal 105a transmits an access request for a content to the edge node 103c. If the edge node 103c caches the requested content main body, the edge node 103c transmits the cached content main body to the user terminal 105a.

At that time, the edge node 103c notifies the data center 101 by an access log message that the edge node 103c has responded to the access request made by the user terminal 105a. The data center 101 keeps track of the access pattern of the user by the access log.

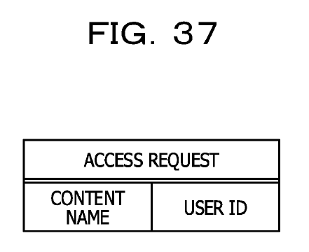

In FIG. 37, a configuration example of the access request is depicted. The access request includes a content name and a user ID. The content name identifies the content to which access is made. The user ID identifies the user who uses the user terminal 105 which transmits the access request.

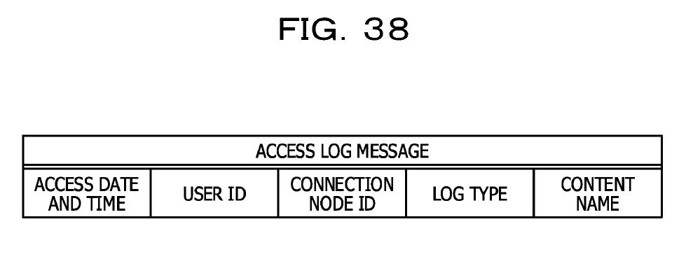

In FIG. 38, a configuration example of the access log message is depicted. The access log message includes an access date and time, a user ID, a connection node ID, a log type, and a content name. The access date and time is a date and time on and at which access to the content was made. The user ID identifies the user who uses the user terminal 105 which transmitted the access request for the content. The connection node ID is an ID of the edge node 103 connected to the user terminal 105 when the access request was made. In the log type, “access request” is set. “Access request” indicates that this log is an access log. The content name indicates the content to which access was made.

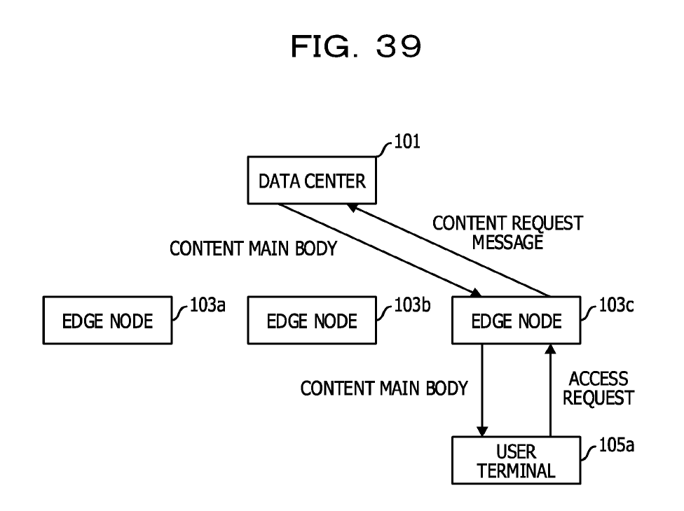

FIG. 39 depicts a data flow which is observed when the edge node 103c does not cache the requested content. In such a case, the edge node 103c transmits a content request message to the data center 101 such that the content is downloaded from the data center 101. In this example, a content main body is transmitted to the user terminal 105a via the edge node 103c.

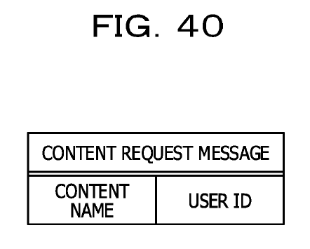

In FIG. 40, a configuration example of the content request message is depicted. The content request message includes a content name and a user ID. The content name identifies the content which is requested. The user ID identifies the user who uses the user terminal 105 which transmitted the access request for the content.

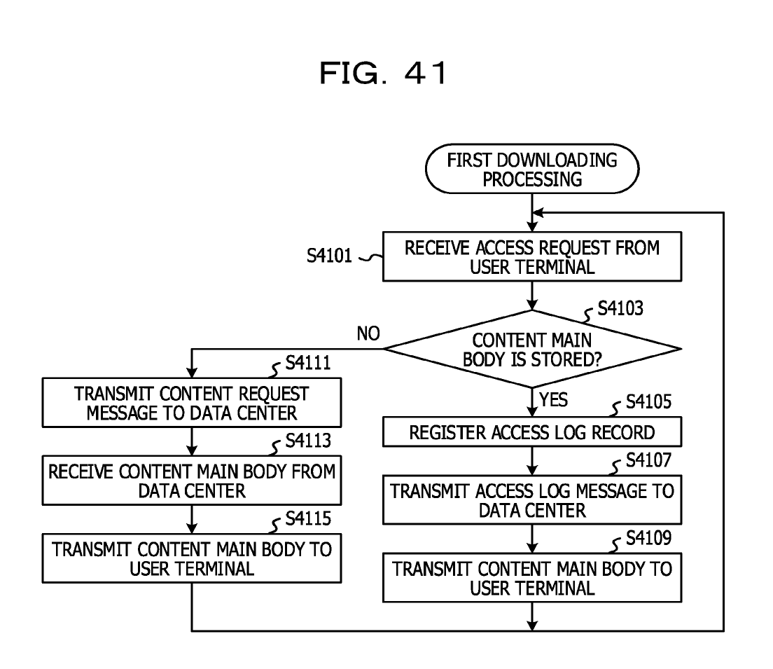

Then, processing in the fourth phase will be described. First, first downloading processing in the edge node 103 will be described. In the first downloading processing, a content main body is downloaded in response to an access request from the user terminal 105. In FIG. 41, a first downloading processing flow is depicted. When the second receiving unit 1005 receives an access request from the user terminal 105 (S4101), the edge service unit 1009 judges whether or not the content main body specified by the content name included in the access request is stored in the content storing unit 1021 (S4103).

If the edge service unit 1009 judges that the content main body is stored in the content storing unit 1021, the edge service unit 1009 registers an access log record in the access log table (S4105). In this example, a day of the week, the day on which the access request was received, and a current time are set as the access date and time of the access log record. The user ID included in the access request is set in the access log record. The ID of this edge node 103 is set as the connection node ID of the access log record.

The edge service unit 1009 transmits an access log message to the data center 101 via the first transmitting unit 1003 (S4107). The access log message is generated in the same manner as the access log record. Moreover, the edge service unit 1009 transmits the content main body stored in the content storing unit 1021 to the user terminal 105 via the second transmitting unit 1007 (S4109). Then, the procedure goes back to the processing described in S4101 and the above-described processing is repeated.

On the other hand, if the edge service unit 1009 judges in S4103 that the content main body is not stored in the content storing unit 1021, the edge service unit 1009 transmits a content request message to the data center 101 via the first transmitting unit 1003 (S4111). In this example, in the content request message, the content name and the user ID which are included in the access request are set.

When the first receiving unit 1001 receives the content main body from the data center 101 (S4113), the edge service unit 1009 transmits the content main body to the user terminal 105 via the second transmitting unit 1007 (S4115). At this time, the content main body may be cached. Then, the procedure goes back to the processing described in S4101 and the above-described processing is repeated.

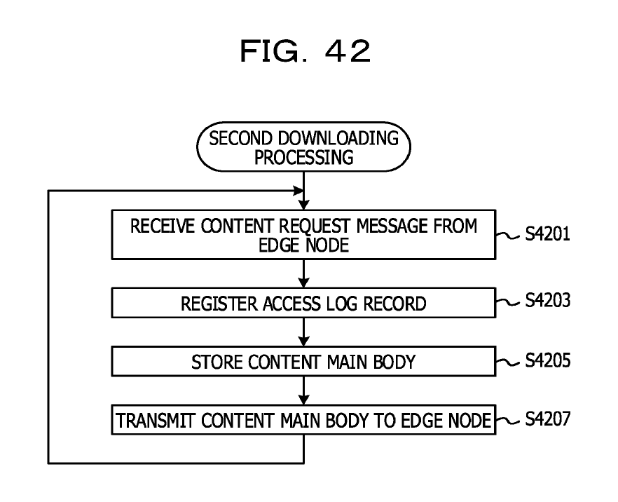

Next, second downloading processing in the data center 101 will be described. In the second downloading processing, a content main body is transmitted in response to a content request message. In FIG. 42, a second downloading processing flow is depicted. When the receiving unit 201 receives a content request message from the edge node 103 (S4201), the center service unit 205 registers an access log record in the access log table (S4203). In this example, a day of the week, the day on which the content request message was received, and a current time are set as the access date and time of the access log record. The user ID included in the content request message is set in the access log record. The ID of the edge node 103 which is the transmission source of the content request message is set as the connection node ID of the access log record.

The center service unit 205 acquires the content main body specified by the content name included in the content request message from the content data storing unit 221 (S4205). The center service unit 205 transmits the acquired content main body to the edge node 103 via the transmitting unit 203 (S4207). Then, the procedure goes back to the processing described in S4201 and the above-described processing is repeated.

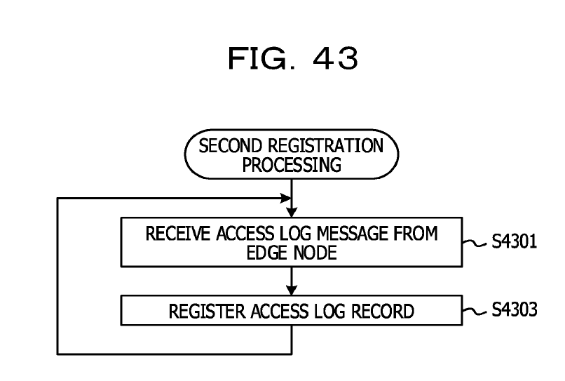

Next, second registration processing in the data center 101 will be described. In FIG. 43, a second registration processing flow is depicted. When the receiving unit 201 receives an access log message from the edge node 103 (S4301), the center service unit 205 registers an access log record in the access log table based on the access log message (S4303). Then, the procedure goes back to the processing described in S4301.

Finally, the fifth phase will be described. In the fifth phase, relation data is updated on a regular basis.

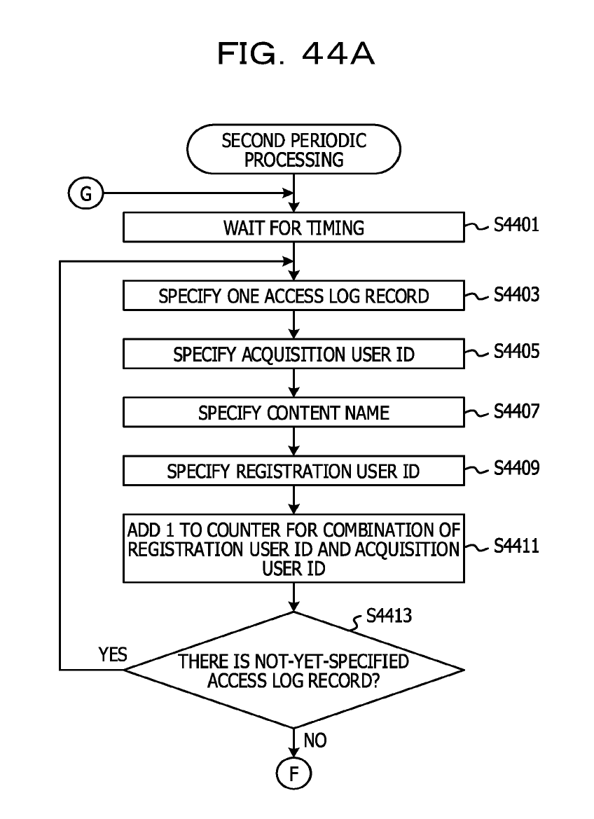

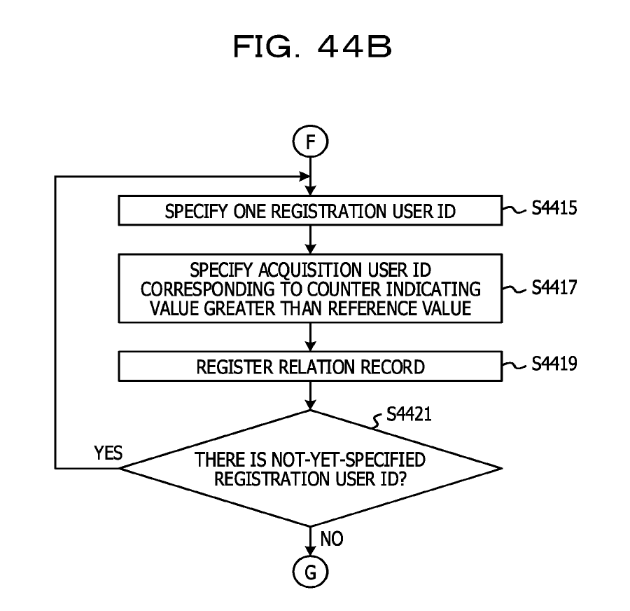

Second periodic processing in the data center 101 will be described. In FIGS. 44A and 44B, a second periodic processing flow is depicted. The generating unit 213 waits for timing in accordance with a predetermined cycle (S4401).

With appropriate timing, the generating unit 213 specifies one access log record included in the access log table (S4403). The generating unit 213 specifies the user ID included in the access log record as an acquisition user ID (S4405).

The generating unit 213 specifies the content name included in the access log record (S4407). Furthermore, the generating unit 213 specifies the registration user ID related to the content name in the attached record stored in the content data storing unit 221 (S4409).

The generating unit 213 updates a counter in the compilation table based on the combination of the registration user ID specified in S4409 and the acquisition user ID specified in S4405. Specifically, the generating unit 213 adds 1 to the counter for this combination (S4411).

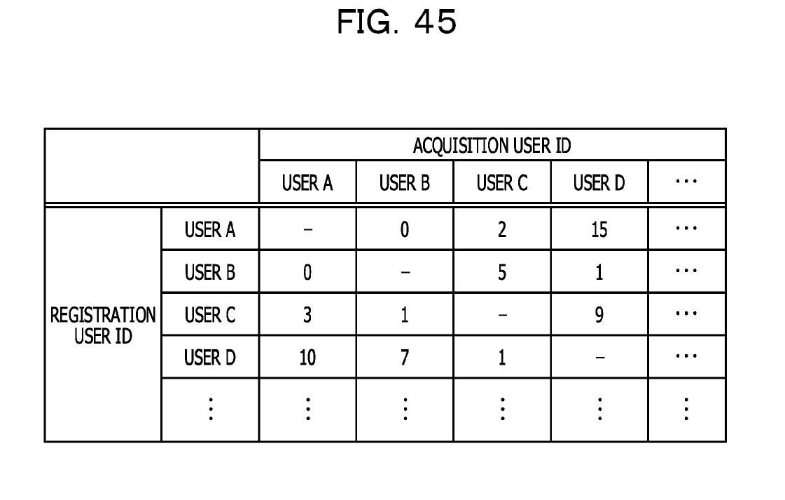

In FIG. 45, an example of the compilation table is depicted. As depicted in FIG. 45, the compilation table has a counter for each combination of the registration user ID and the acquisition user ID.

Back in FIG. 44A, the generating unit 213 judges whether or not there is an access log record which is not yet specified in S4403 (S4413). If the generating unit 213 judges that there is a not-yet-specified access log record, the procedure goes back to the processing described in S4403 and the above-described processing is repeated.

On the other hand, if the generating unit 213 judges that there is not a not-yet-specified access log record, the procedure proceeds to processing in S4415 depicted in FIG. 44B via a terminal F. The generating unit 213 specifies one registration user ID to be compiled (S4415). The generating unit 213 specifies, of the counters corresponding to the registration user ID, the acquisition user ID corresponding to the counter indicating a value greater than a reference value (S4417). However, the generating unit 213 may specify the acquisition user ID corresponding to the counter indicating the maximum value.

The generating unit 213 registers the relation record including the registration user ID specified in S4415 and the acquisition user ID specified in S4417 in the relation data (S4419).

The generating unit 213 judges whether or not there is a registration user ID which is not yet specified in S4415 (S4421). If the generating unit 213 judges that there is a not-yet-specified registration user ID, the procedure goes back to the processing described in S4415 and the above-described processing is repeated.

On the other hand, if the generating unit 213 judges that there is not a not-yet-specified registration user ID, the procedure goes back to the processing described in S4401 of FIG. 44A via a terminal G and the above-described processing is repeated.

This embodiment helps increase the efficiency of content distribution among the edge nodes 103. For example, it becomes easier to determine the order of advance distribution of a content.

Moreover, this embodiment helps make more efficient advance distribution of a content with which a plurality of users may be concerned in the same time period.

Furthermore, it becomes easier to determine a content to be placed in advance in the edge node 103.

Incidentally, a time period does not have to be limited to a time period on a particular day of the week. That is, processing may be performed by replacing a combination of a day of the week and a time period with a common time period on each day of the week.

### Second Embodiment

In this embodiment, an example in which a pattern record is included in an advance response message will be described.

The configurations of some of the messages in the third phase depicted in FIG. 25 in this embodiment are different from those described above. Hereinafter, those configurations will be described.

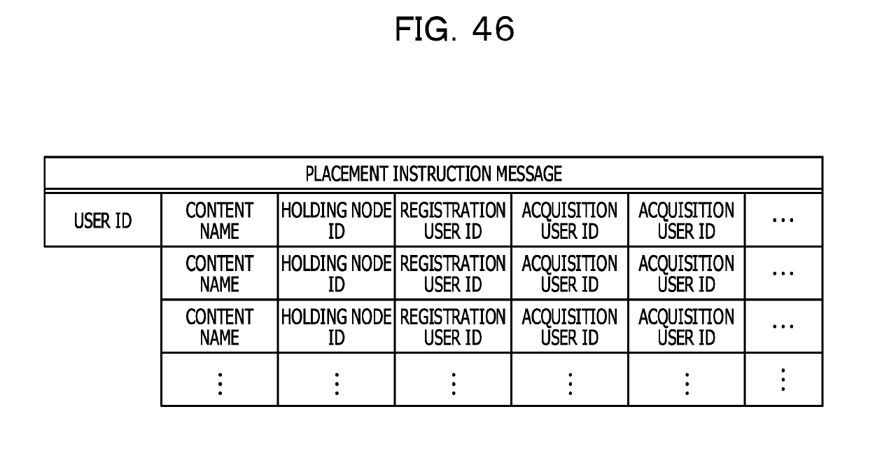

In FIG. 46, a configuration example of a placement instruction message according to a second embodiment is depicted. The placement instruction message according to the second embodiment includes a registration user ID and an acquisition user ID in a state in which the registration user ID and the acquisition user ID are related to a set of a content name and a holding node ID. That is, the content name, the holding node ID, the registration user ID, and the acquisition user ID correspond to an entry. Incidentally, there is one or more than one acquisition user ID.

The registration user ID identifies the registration user of a content to be placed. The acquisition user ID identifies the acquisition user related to the registration user. That is, the acquisition user ID specifies the user who may make an attempt to download the content to be placed.

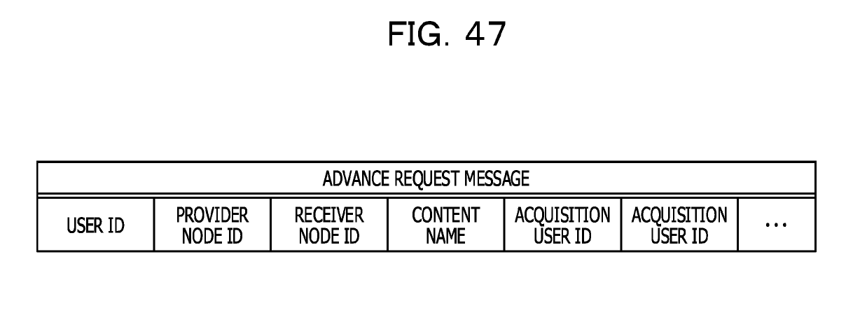

In FIG. 47, a configuration example of an advance request message according to the second embodiment is depicted. The advance request message according to the second embodiment includes one or more than one acquisition user ID. The acquisition user ID included in the advance request message coincides with the acquisition user ID related to the content name in the placement instruction message.

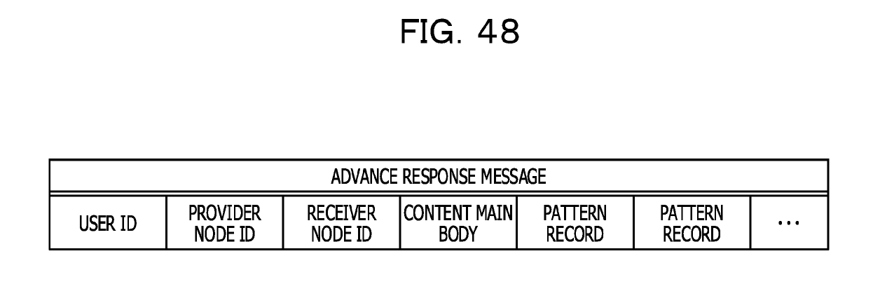

In FIG. 48, a configuration example of an advance response message according to the second embodiment is depicted. The advance response message according to the second embodiment includes a pattern record corresponding to the acquisition user ID included in the advance request message. A plurality of pattern records sometimes corresponds to one acquisition user ID. The pattern record has the same configuration as the pattern record in the access pattern table depicted in FIG. 6.

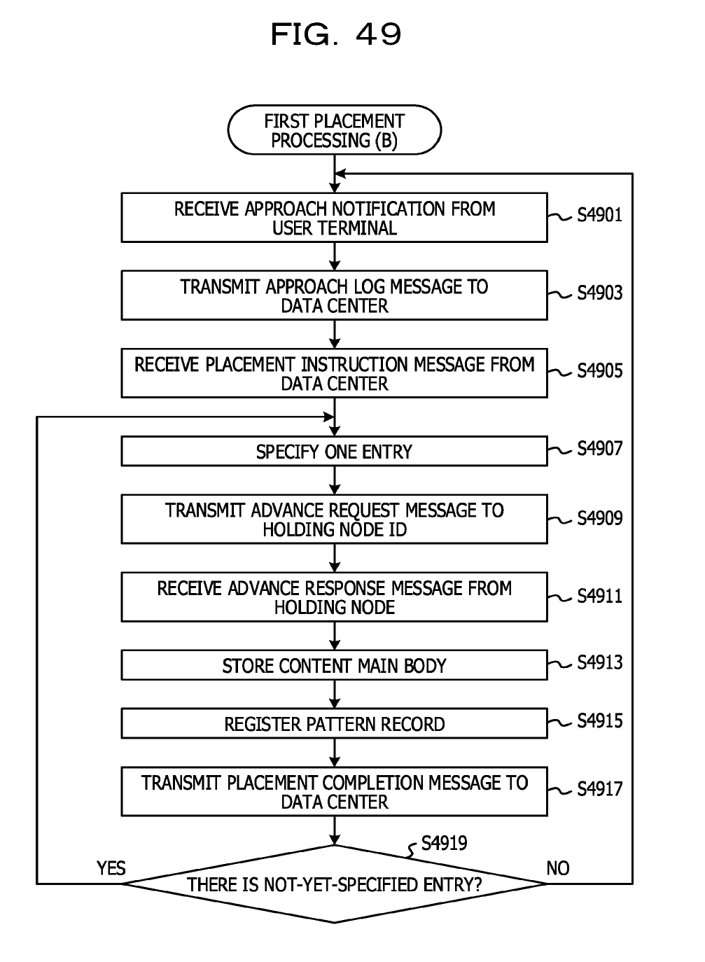

Then, processing will be described. In this embodiment, in the edge node 103, in place of the first placement processing (A), first placement processing (B) is executed. In FIG. 49, a first placement processing (B) flow is depicted.

Processing described in S4901 and S4903 is the same as the processing described in S3101 and S3103 in the first placement processing (A) depicted in FIG. 31.

The description of a placement instruction message which is received from the data center 101 in S4905 is different from the description in the case of the first placement processing (A) as depicted in FIG. 46.

Processing described in S4907 is the same as the processing described in S3107 in the first placement processing (A) depicted in FIG. 31.

The description of an advance request message which is transmitted to the holding node ID in S4909 is different from the description in the case of the first placement processing (A) as depicted in FIG. 47. In this example, the acquisition user ID set in the entry specified in S4907 is set in the advance request message.

The description of an advance response message which is received from the holding node in S4911 is different from the description in the case of the first placement processing (A) as depicted in FIG. 48.

Processing described in S4913 is the same as the processing described in S3113 in the first placement processing (A) depicted in FIG. 31.

The placement agent 1013 registers each pattern record included in the advance response message in the access pattern table (S4915).

Processing described in S4917 and S4919 is the same as the processing described in S3115 and S3117 in the first placement processing (A) depicted in FIG. 31.

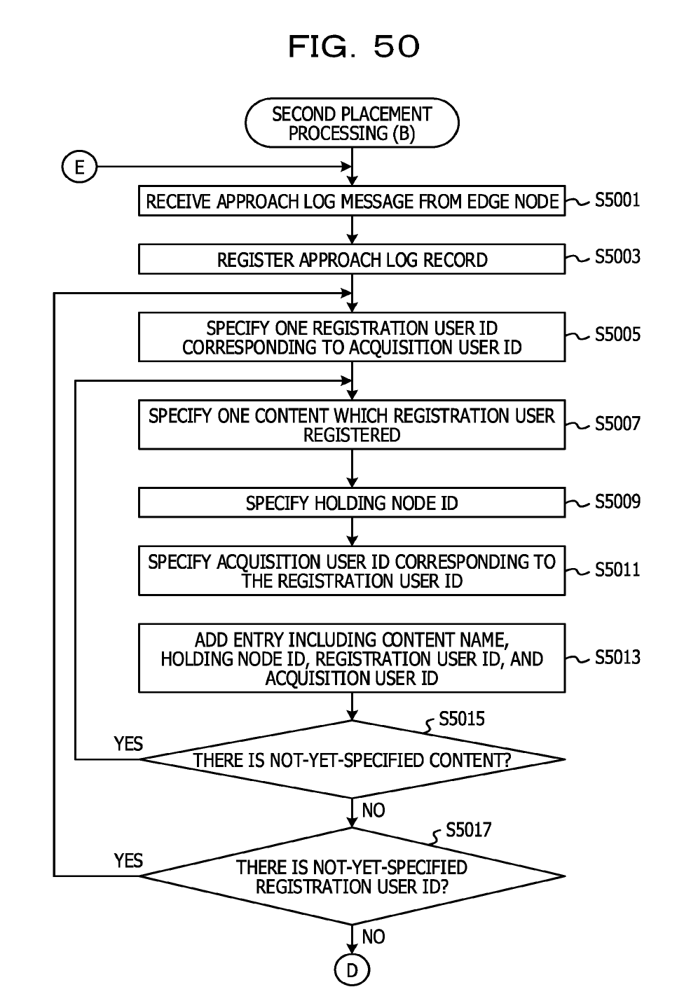

Moreover, in this embodiment, in the edge node 103, in place of the second placement processing (A), second placement processing (B) is executed. In the second placement processing (B), the placement instruction message depicted in FIG. 46 is generated. In FIG. 50, a second placement processing (B) flow is depicted.

Processing described in S5001 to S5009 is the same as the processing described in S3201 to S3209 in the second placement processing (A) depicted in FIG. 32.

The placement controlling unit 211 specifies the acquisition user ID related to the registration user ID in the relation data (S5011).

The placement controlling unit 211 adds an entry including the content name, the holding node ID, the registration user ID, and the acquisition user ID specified in S5011 to the placement instruction message (S5013).

Processing described in S5015 and S5017 is the same as the processing described in S3213 and S3215 in the second placement processing (A) depicted in FIG. 32. Furthermore, as in the case of the second placement processing (A), the processing depicted in FIG. 33 is executed.

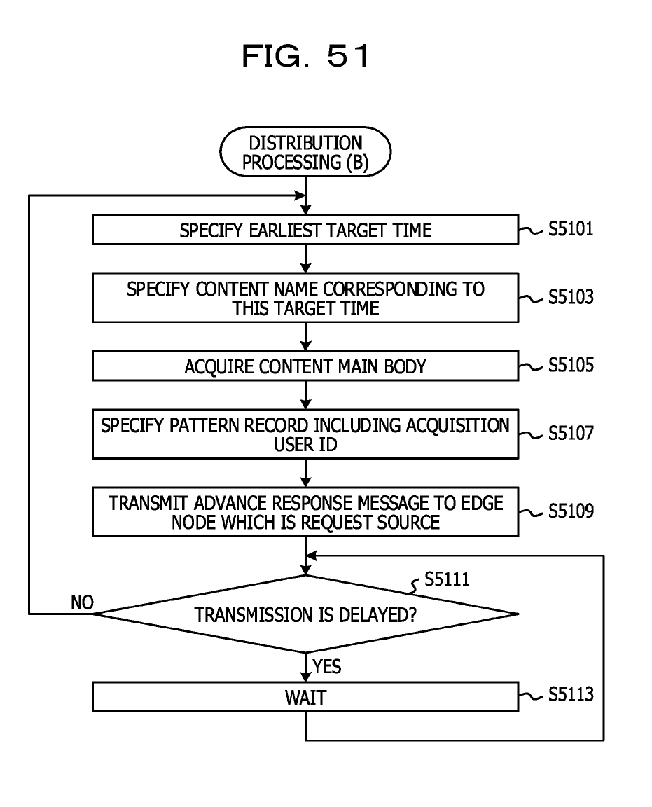

Moreover, in this embodiment, in the edge node 103, in place of the distribution processing (A), distribution processing (B) is executed. In the distribution processing (B), the advance response message depicted in FIG. 48 is generated. In FIG. 51, a distribution processing (B) flow is depicted.

Processing described in S5101 to S5105 is the same as the processing described in S3501 to S3505 in the distribution processing (A) depicted in FIG. 35.

The placement agent 1013 specifies the pattern record including the acquisition user ID included in the advance request message corresponding to the target time (S5107).

In an advance response message to be transmitted to the edge node 103 which is the request source via the first transmitting unit 1003 in S5109, the pattern record specified in S5107 is set.

Processing described in S5111 and S5113 is the same as the processing described in S3509 and S3511 in the distribution processing (A) depicted in FIG. 35.

This embodiment helps increase the efficiency of transfer of a content in the edge node 103 to which the content has been distributed. For example, when another edge node 103 requests advance distribution of the content, it becomes easier to determine proper transfer timing in accordance with the user who approaches the other edge node 103.

Incidentally, the above-described data center 101 is an example of a center server device included in the content sharing system. The above-described edge node 103 is an example of an edge server device included in the content sharing system.

While the embodiments have been described, an embodiment is not limited thereto. For example, the above-described functional block configuration sometimes does not coincide with a program module configuration.

Moreover, the above-described configuration of each storage region is an example and does not have to be the configuration mentioned above. Furthermore, in each processing flow, as long as the same processing result is obtained, the order of processing may be changed or a plurality of processing may be executed concurrently.

Incidentally, the above-described data center 101 and edge node 103 are computer devices, and, as depicted in FIG. 52, memory 2501, a central processing unit (CPU) 2503, a hard disk drive (HDD) 2505, a display controlling unit 2507 connected to a display device 2509, a drive device 2513 for a removable disk 2511, an input device 2515, a communication controlling unit 2517 for connection to a network are connected to one another by a bus 2519. An operating system (OS) and an application program for performing the processing in the embodiments are stored in the HDD 2505, and, when the OS and the application program are executed by the CPU 2503, the OS and the application program are read to the memory 2501 from the HDD 2505. The CPU 2503 makes the display controlling unit 2507, the communication controlling unit 2517, and the drive device 2513 perform predetermined operations by controlling the display controlling unit 2507, the communication controlling unit 2517, and the drive device 2513 in accordance with the description of processing of the application program. Moreover, data which is used in the course of processing is mainly stored in the memory 2501, but the data may be stored in the HDD 2505. In the above embodiments, the application program for performing the above-described processing is stored in the computer-readable removable disk 2511 and distributed and is installed on the HDD 2505 from the drive device 2513. The application program is sometimes installed on the HDD 2505 via a network such as the Internet and the communication controlling unit 2517. Such a computer device implements the above-described various functions as a result of hardware such as the CPU 2503 and the memory 2501 described above and programs such as the OS and the application program described above operating organically in cooperation with each other.

The embodiments described above may be summarized as follows.

A pattern transmission method according to the embodiments includes processing: (A) from a first edge server which received a request for content access from a terminal of a first user, a log of the request is received, (B) based on the above log, a pattern concerning timing with which the first user requests access to the content, and (C) the above pattern is transmitted to a second edge server with a track record of connecting to a terminal of a second user related to the first user.

Doing so helps increase efficiency of content distribution among the edge servers. For example, it becomes easier to determine the order of advance distribution of a content.

Furthermore, the second edge server with a track record of connecting to the terminal of the second user in a time period in which the above request was received from the first user may be specified.

Doing so helps make more efficient advance distribution of a content with which a plurality of users may be concerned in the same time period.

In addition, when, from any edge server, a notification indicating that the terminal of the first user has approached the edge server is received, an instruction to place the content registered by the second user may be transmitted to the edge server.

Doing so makes it easier to determine in advance a content to be placed in the edge server.

A pattern transmission method according to the embodiments includes processing: (A) from an edge server included in the content sharing system, a request for content distribution is received, (B) a pattern concerning timing with which access to a content is requested by a user specified in the above-described request is specified, and (C) the above-described pattern is transmitted to the above-described edge server with a content to be distributed.

Doing so helps increase the efficiency of transfer of a content in the edge server to which the content has been distributed. For example, when another edge server requests advance distribution of the content, it becomes easier to determine proper transfer timing in accordance with the user who approaches the other edge server.

Incidentally, it is possible to create a program for making a computer perform processing by the above-described methods, and this program may be stored in computer-readable storage media or storage devices such as a flexible disk, a CD-ROM, a magneto-optical disk, semiconductor memory, and a hard disk. Incidentally, the result obtained in the course of processing is temporarily stored generally in a storage device such as main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A system comprising:
a server that manages a plurality of contents; and
a plurality of nodes that communicates with the server and manages a part of the plurality of contents,
wherein the server includes first circuitry configured to:
receive, from a first node among the plurality of nodes, a notification that a first user terminal from among a plurality of user terminals has approached the first node, the plurality of user terminals communicating with one of the plurality of nodes when the plurality of user terminals are within radio communication range of the one of the plurality of nodes,
specify a second user terminal related to the first user terminal,
specify a second node holding a content uploaded by the second user terminal, the second node being from among the plurality of nodes, the content being from among the plurality of contents, and
transmit, to the first node, a message for making the first node download the content from the second node, and
wherein the first node includes a memory and second circuitry configured to:
receive the message from the server,
transmit, to the second node, a request message requesting the content according to the message from the server,
receive the content from the second node,
store the content into the memory, and
transmit the content acquired from the memory to the first user terminal when receiving an access request for the content from the first user terminal.

2. The system according to claim 1, wherein the second node includes third circuitry configured to:
receive an access pattern of the first user terminal from the server,
set a target time in accordance with the access pattern when receiving the request message from the first node, and
transmit the content to the first node in accordance with the target time.

3. The system according to claim 2, wherein the access pattern is generated by the server based on an access log of access to the plurality of contents made by the plurality of user terminals.

4. The system according to claim 3, wherein the access pattern further includes first time period from starting time when the plurality of user terminals connects to the plurality of nodes till request time when the plurality of user terminals requests one of the plurality of contents.

5. The system according to claim 4, wherein the access pattern further includes at least one of second time period and a day of a week in and on which the access by the plurality of user terminals is highly likely to be made.

6. The system according to claim 1, wherein
the first circuitry in the server is configured to specify the second user terminal based on relation information indicating a relationship between the plurality of user terminals,
the second user terminal has uploaded another content downloaded by the first user in a past, and
the relation information is generated based on a log.

7. The system according to claim 1, wherein the second circuitry in the first node is configured to request another content from the server when the second circuitry receives another access request for the another content from the first user terminal, and when the second circuitry does not store the another content in the memory.

8. The system according to claim 1, wherein
the server is provided in a wide area network,
the plurality of nodes is respectively provided in a local network, and
a band of the local network is wider than a band of the wide area network.

9. A method that is executed by a computer, the method comprising:
receiving a log of a request for content access from a first edge server which has received the request from a terminal of a first user;
specifying, based on the log, a pattern concerning timing with which access to a content is requested by the first user; and
transmitting the pattern to a second edge server with a track record of connecting to a terminal of a second user related to the first user.

10. The method according to claim 9, further comprising:
specifying the second edge server with the track record of connecting to the terminal of the second user in a time period in which the request has been received from the first user.

11. The method according to claim 9, further comprising:
transmitting, when receiving, from one of edge servers, a notification indicating that the terminal of the first user has approached the one edge server, an instruction to place a content registered by the second user to the one edge server.

12. A control method executed by a server that manages a plurality of contents and communicates with a plurality of nodes, the control method comprising:
receiving, from a first node among the plurality of nodes, a notification that a first user terminal from among a plurality of user terminals has approached the first node, the plurality of user terminals communicating with one of the plurality of nodes when the plurality of user terminals are within radio communication range of the one of the plurality of nodes;
specifying a second user terminal related to the first user terminal;
specifying a second node holding a content uploaded by the second user terminal, the second node being from among the plurality of nodes, the content being from among the plurality of contents; and
transmitting, to the first node, a message for making the first node download the content from the second node.

13. The control method according to claim 12, wherein the first node receives the message from the server, transmits a request message requesting the content to the second node, stores the content into a memory after receiving the content, and transmits the content to the first user terminal when receiving an access request for the content from the first user terminal.

14. The control method according to claim 12, wherein the second node receives an access pattern of the first user terminal from the server, sets a target time in accordance with the access pattern when receiving the request message from the first node, and transmits the content to the first node in accordance with the target time.

15. The control method according to claim 14, further comprising:
generating the access pattern based on an access log of access to the plurality of contents made by the plurality of user terminals; and
transmitting the access pattern to the plurality of nodes.

16. The control method according to claim 15, wherein the access pattern further includes first time period from starting time when the plurality of user terminals connects to the plurality of nodes till request time when the plurality of user terminals requests one of the plurality of contents.

17. The control method according to claim 16, wherein the access pattern further includes at least one of second time period and a day of a week in and on which the access by the plurality of user terminals is highly likely to be made.

18. The control method according to claim 12, wherein the second user terminal is specified based on relation information indicating a relationship between the plurality of user terminals,
the second user terminal has uploaded another content downloaded by the first user in a past, and
the relation information is generated based on a log.

19. The control method according to claim 12, wherein
the server is provided in a wide area network,
the plurality of nodes is respectively provided in a local network, and
a band of the local network is wider than a band of the wide area network.
